(19) United States
(12) Patent Application Publication
(10) Pub. No.: US 2025/0174218 A1
(43) Pub. Date: May 29, 2025

(54) SIGNAL PROCESSING DEVICE, SOUND OUTPUT DEVICE, AND SIGNAL PROCESSING METHOD

(71) Applicant: Sony Group Corporation, Tokyo (JP)

(72) Inventors: Yasunobu Murata, Tokyo (JP); Shinpei Tsuchiya, Saitama (JP); Yoshinori Tamori, Tokyo (JP); Tetsunori Itabashi, Kanagawa (JP); Akifumi Kono, Tokyo (JP)

(73) Assignee: Sony Group Corporation, Tokyo (JP)

(21) Appl. No.: 18/843,463

(22) PCT Filed: Feb. 15, 2023
(86) PCT No.: PCT/JP2023/005311

§ 371 Date: Sep. 3, 2024

(30) Foreign Application Priority Data
Mar. 10, 2022 (JP) 2022-037152

(51) Int. Cl. G10K 11/175; G10K 11/178; H04R 1/40

(52) U.S. Cl. CPC G10K 11/1752; G10K 11/17881; H04R 1/406

(57) ABSTRACT

A signal processing device includes a masking determination unit that determines a masking state of a content sound and an ambient sound on the basis of content sound data of multiple channels output from multiple sound output drivers disposed on a sound output device, ambient sound data obtained by multiple microphones disposed on the sound output device and each collecting the ambient sound, and information indicating an arrival direction of the ambient sound, and a sound processing control unit that performs control associated with sound processing according to a determination result of the masking state obtained by the masking determination unit.

### TECHNICAL FIELD

The present technology relates to a signal processing device, a sound output device, and a signal processing method, and particularly to a technology appropriately applicable to a field of stereoscopic sound reproduction equipped with multiple sound output drivers.

### BACKGROUND ART

For example, a technology of stereoscopic sound reproduction, such as 3D (three dimensions) audio and 360-degree audio, has been developed. According to a headphone provided for stereoscopic sound reproduction, sound output drivers (driver units) for multiple channels are disposed on each of a left-ear unit and a right-ear unit to enable a user to perceive content sounds in a variety of directions. Moreover, a certain type of this headphone includes multiple microphones for noise cancelling to collect ambient sounds in a variety of directions.

A generally-called multimicrophone and multidriver headphone, which corresponds to this type of headphone, may be used to hear content such as 3D audio under an environment containing ambient sounds.

PTL 1 identified below discloses a technology associated with transmission of three-dimensional (3D) audio.

### CITATION LIST

### Patent Literature

### [PTL 1]

JP 2021-152677A

### SUMMARY

### Technical Problem

Suppose herein that one of two sounds, i.e., a content sound and an ambient sound, is masked by the other sound. Specifically, suppose such a case where the ambient sound is masked by the content sound and not recognized by a user, or a such a case where a part of content sound components is masked by the ambient sound. For example, for achieving noise cancelling which designates the ambient sound as noise, it is also possible that a part of the content sound components is masked by uncancelled components of the ambient sound.

A more efficient process or a process desirable for the user may be achievable by determining the foregoing

Accordingly, proposed in the present technology is such a technology which achieves processing suited for situations of content sounds and ambient sounds.

### Solution to Problem

A signal processing device according to the present technology includes a masking determination unit that determines a masking state of a content sound and an ambient sound on the basis of content sound data of multiple channels output from multiple sound output drivers disposed on a sound output device, ambient sound data obtained by multiple microphones disposed on the sound output device and each collecting the ambient sound, and information indicating an arrival direction of the ambient sound; and a sound processing control unit that performs control associated with sound processing according to a determination result of the masking state obtained by the masking determination unit.

Assumed is such a case where the sound output device such as a headphone includes inside a housing the multiple sound output drivers to reproduce stereoscopic sound, and the multiple microphones each collecting an ambient sound. In this case, the masking state of the content sound data and the ambient sound data is determined, and sound processing control corresponding to this masking state is performed.

### BRIEF DESCRIPTION OF DRAWINGS

FIG. 1 is a block diagram of a headphone according to a first embodiment of the present technology.

FIG. 2 is a schematic explanatory diagram of microphones and sound output drivers of the headphone according to the embodiment.

FIG. 3 is an explanatory diagram of sounds heard by a person wearing the headphone according to the embodiment.

FIG. 4 is an explanatory diagram of positions of sound output drivers and noise cancelling characteristics.

FIG. 5 is an explanatory diagram of a minimum hearing limit and same-time masking.

FIG. 6 is an explanatory diagram of masking in a noise applied state.

FIG. 7 is an explanatory diagram of masking in a noise applied state.

FIG. 8 is an explanatory diagram of masking when uncancelled noise is present.

FIG. 9 is an explanatory diagram of masking when uncancelled noise is present.

FIG. 10 is an explanatory diagram of space masking.

FIG. 11 is an explanatory diagram illustrating a case where arrival directions of a noise and a content sound are the same.

FIG. 12 is an explanatory diagram of masking in a case where the arrival directions of the noise and the content sound are the same.

FIG. 13 is an explanatory diagram illustrating a noise cancelling applied state in a case where the arrival directions of the noise and the content sound are the same.

FIG. 14 is an explanatory diagram of masking in a noise cancelling applied state in a case where the arrival directions of the noise and the content sound are the same.

FIG. 15 is an explanatory diagram of masking in a case where the arrival directions of the noise and the content sound are the same.

FIG. 16 is an explanatory diagram of a case where the arrival directions of the noise and the content sound are different.

FIG. 17 is an explanatory diagram illustrating a noise cancelling applied state in a case where the arrival directions of the noise and the content sound are different.

FIG. 18 is an explanatory diagram of masking in a noise cancelling applied state in a case where the arrival directions of the noise and the content sound are different.

FIG. 19 is an explanatory diagram illustrating a case where arrival directions of noises are contained in arrival directions of content sounds.

FIG. 20 is an explanatory diagram of a masking state different for each arrival direction.

FIG. 21 is an explanatory diagram illustrating a case where noise cancelling is applied in the masking state different for each arrival direction.

FIG. 22 is an explanatory diagram in a state after execution of noise cancelling.

FIG. 23 is an explanatory diagram illustrating a case where an arrival direction of a noise is present in a direction other than the arrival directions of the content sounds.

FIG. 24 is an explanatory diagram of a masking state different for each arrival direction.

FIG. 25 is an explanatory diagram illustrating a case where noise cancelling is applied in the masking state different for each arrival direction.

FIG. 26 is an explanatory diagram illustrating a state after execution of noise cancelling.

FIG. 27 is a flowchart of a processing example performed by a determination unit according to the embodiment.

FIG. 28 is a flowchart of the processing example performed by the determination unit according to the embodiment.

FIG. 29 is a block diagram of a headphone according to a second embodiment.

FIG. 30 is an explanatory diagram of a display example of a message of an ambient sound notification displayed on a host device.

FIG. 31 is an explanatory diagram of a display example of a notification of an ambient sound and an arrival direction displayed on the host device.

FIG. 32 is an explanatory diagram of a display example of a notification of an ambient sound and an arrival direction displayed on the host device.

FIG. 33 is an explanatory diagram of a display example of display containing a masking state displayed on the host device.

FIG. 34 is an explanatory diagram of a display example of display containing a masking state displayed on the host device.

FIG. 35 is an explanatory diagram of a display example of display containing a masking state displayed on the host device.

FIG. 36 is a flowchart of a processing example performed by a determination unit according to an embodiment.

### DESCRIPTION OF EMBODIMENTS

Embodiments will be hereinafter described in a following order.
<1. First embodiment>
<2. Second embodiment>
<3. Summary and modifications>

### 1. First Embodiment

Described in the embodiments of the present disclosure will be an example case where content containing stereoscopic sound data, such as 3D audio, is heard using a multimicrophone and multidriver type headphone which is an example of a sound output device. Note that each of sound output drivers mounted on this headphone will be hereinafter simply referred to as a “driver” as well.

Initially, chiefly described in a first embodiment will be a process for handling an increase in a transmission volume of content sound data used for stereoscopic sound reproduction.

For achieving stereoscopic sound reproduction, a considerably larger number of sound sources are required than that number of conventional content reproducing two-channel stereo sounds and the like. Accordingly, a transmission bit rate of content sound data has been bloated in the current circumstances.

Meanwhile, there exist ambient sounds (noises) emitted from surroundings and reaching eardrums in addition to the content sounds. In this case, a phenomenon called a masking effect is utilized to achieve reduction of the transmission bit rate of the content sound data, improvement of an S/N (Signal-to-Noise Ratio) of the content sound data, improvement of a sense of sound separation, improvement of a noise cancelling effect (noise cancelling will be hereinafter referred to as “NC”), or elongation of a battery life of the headphone due to reduction of power consumption.

There is a phenomenon, i.e., the masking effect, where a certain sound is blocked and cut off by a different sound, and thus becomes unperceivable. In addition, when two sound sources are present, there may be caused such a masking effect where signals of one of the sound sources block signals of the other sound source. The side which masks the other side will be referred to as a “masker,” and the masked side will be referred to as a “maskee.”

According to the present embodiment, this masking effect is utilized to analyze which signals are dominant (masker), and by what degree the masker deteriorates the other signals (maskee) or whether the masker cancels the maskee during viewing and hearing of stereoscopic sound content under a noise environment, on the basis of noise, content sound data of stereoscopic sound, and a noise arrival direction.

Thereafter, in a case where the noise constitutes the masker according to an analysis result, quantization bits of content sound data of stereoscopic sound reproduction are reduced to achieve reduction of a transmission bit rate.

Moreover, when the content sound is heard under a noise environment, an NC function is turned on. At this time, each quality of the NC effect, the S/N of the content sound after NC processing, and the like is dependent on the arrival direction of the noise. Accordingly, which driver of the headphone is to be used to cancel the noise, or which driver need not be used for noise cancelling is determined, and settings are changed according to this determination. In this manner, a more comfortable S/N of reproduced sound, a sense of sound separation, and improvement of the NC effect are achieved.

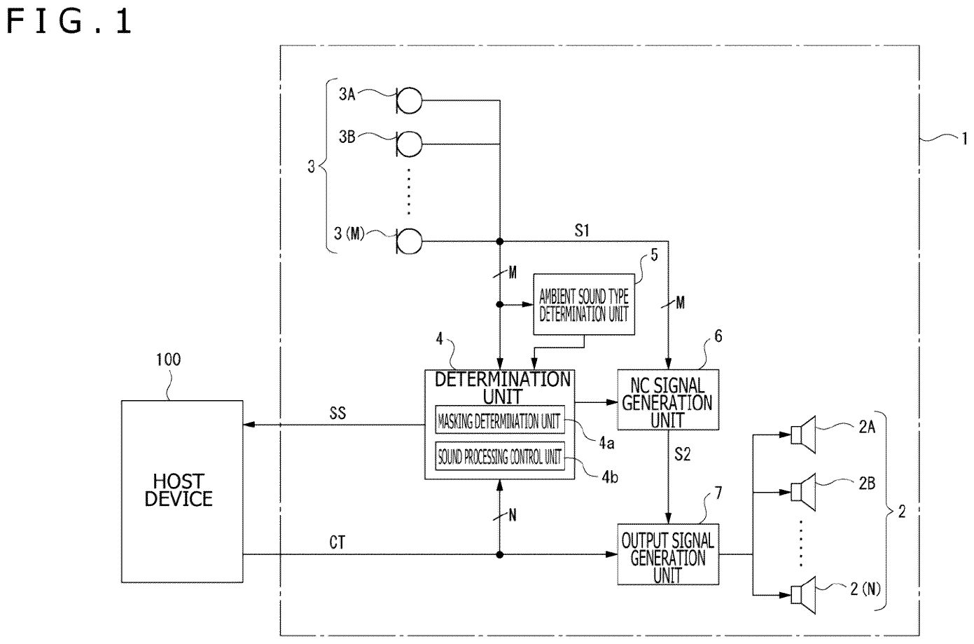

FIG. 1 illustrates a configuration example of a headphone 1 according to the first embodiment.

The headphone 1 receives content sound data CT transmitted from a host device 100 as stereoscopic sound data, and outputs reproduced sounds corresponding to the content sound data CT.

Incidentally, it is assumed herein that the host device 100 is a device separated from the headphone 1. However, the host device 100 may be a device unit provided inside the headphone 1. For example, the host device 100 may be a sound streaming control unit inside the headphone 1. Accordingly, the host device 100 of the embodiment may have any form as long as the host device 100 is a device or a circuit unit constituting a source of the content sound data CT reproduced by the headphone 1. In addition, the host device 100 may be either formed integrally with or separately from the headphone 1.

For example, N drivers 2 (2A, 2B, and up to 2(N)) are provided on the headphone 1 configured as above to output N-channel stereoscopic sounds. The drivers 2A, 2B, and up to 2(N) are disposed at different positions corresponding to the respective channels inside each of left and right housings of the headphone 1.

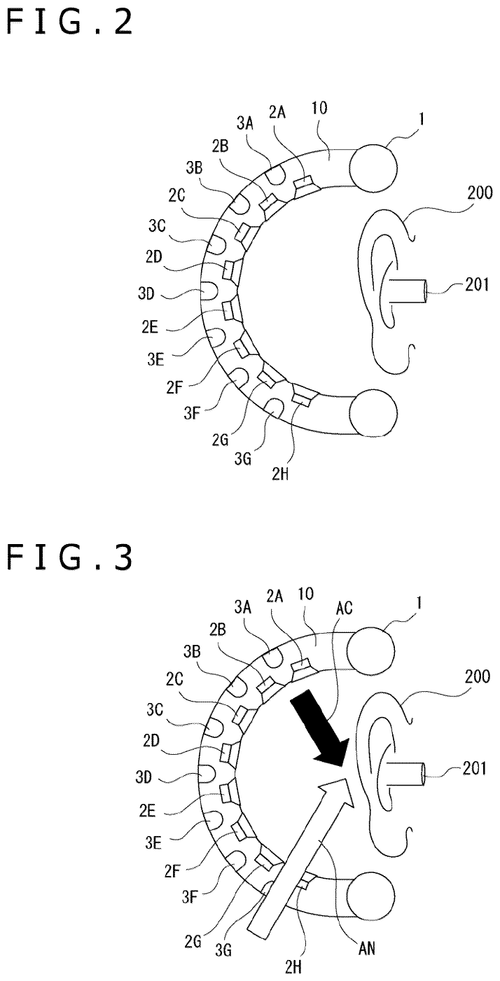

For example, as schematically illustrated in FIG. 2, each of the drivers 2A, 2B, and up to 2(N) is provided within the housing 10 so as to emit sound toward an ear 200 of a user. This configuration varies arrival directions of the respective channels of content sounds reaching an eardrum 201.

Note that only the housing 10 on one of the left and right ears of the user will be depicted and described for simplifying the explanation. This explanation is similarly applicable to the other housing. The N-channel (N) drivers are provided on each of the left and right housings 10. FIG. 1 also illustrates a configuration corresponding to one of the ears 200. This configuration is similarly applicable to the other side.

As illustrated in FIGS. 1 and 2, M microphones 3 (3A, 3B, and up to 3(M)) are provided at different positions in directions toward the outside of the housing 10. Ambient sounds of M channels are collected by the microphones 3. For example, the microphones 3 are disposed at positions appropriate for NC processing performed by an FF (feedforward) system.

Note that FIG. 2 is only a schematic diagram. The drivers 2 and the microphones 3 are not necessarily arranged in a cross-sectional direction of the housing 10 as illustrated in the figure.

For example, the multiple drivers 2 are disposed at respective positions on the inner surface side of the housing 10, while the multiple microphones 3 are disposed at respective positions on the outer surface side of the housing 10.

The host device 100 for the headphone 1 is a device constituting a source of the content sound data CT. For example, various types of devices such as a smartphone, an HMD (head mounted display), a game console, a tablet, and a personal computer are assumed to constitute the host device 100.

For example, the host device 100 displays content video images on a display unit equipped on the host device 100, and also transmits the content sound data CT to the headphone 1. In this manner, the user is allowed to view and hear content containing video images and sounds. In this case, the content sound data CT is N-channel stereoscopic sound data reproduced by the headphone 1. Specifically, it is assumed that the content sound data CT is data to which signal processing corresponding to the number of channels and the positions of the drivers 2 of the headphone 1 has been applied on the host device 100 side.

For example, the headphone 1 receiving the content sound data CT has respective functions as a determination unit 4, an ambient sound type determination unit 5, an NC signal generation unit 6, and an output signal generation unit 7 implemented by one or multiple microprocessors.

For example, sounds collected by the microphones 3 are converted into ambient sound data S1 as digital data in an output stage of the microphones 3, and supplied to the determination unit 4, the ambient sound type determination unit 5, and the NC signal generation unit 6. Note that conversion into the digital data may be performed in an input stage of microprocessors constituting the respective units. For example, each of the determination unit 4, the ambient sound type determination unit 5, and the NC signal generation unit 6 acquires the ambient sound data S1 as digital data by using an A/D conversion terminal provided on each of the microprocessors.

The determination unit 4 is a function of acquiring the ambient sound data S1 received from the microphones 3 and the content sound data CT, and determining and controlling these data. Specifically, the determination unit 4 includes functions of a masking determination unit 4a and a sound processing control unit 4b.

The masking determination unit 4a performs a process for determining a masking state of content sounds and ambient sounds by using the N-channel content sound data CT output from the N-channel drivers 2, the M-channel ambient sound data S1 obtained by the microphones 3, and information indicating arrival directions of the ambient sounds.

Accordingly, the masking determination unit 4a determines the arrival directions of the ambient sounds (noises) on the basis of the M-channel ambient sound data S1.

Moreover, the masking determination unit 4a calculates frequency characteristics of the M-channel ambient sound data S1.

Furthermore, the masking determination unit 4a calculates frequency characteristics of the N-channel content sound data CT.

The masking determination unit 4a determines the masking state associated with the ambient sounds and the content sounds according to these items of information. Details of this point will be described below.

Note that the sound data in each of the channels in the content sound data CT in the case of the stereoscopic sound content as presented in the present embodiment is sound data output from one of the drivers 2 different from each other. In other words, a channel number corresponds to the position of the corresponding driver 2. In this case, channel information associated with the content sound data CT corresponds to information indicating the arrival directions of the content sounds with respect to the user. Accordingly, a level of the content sound in each of the arrival directions can be determined on the basis of a level of the corresponding channel in the content sound data CT of the multiple channels.

In other words, the content sound data CT itself contains information associated with the arrival direction of the content sound with respect to the user.

The sound processing control unit 4b controls sound processing according to a determination result of the masking state obtained by the masking determination unit 4a.

For example, the sound processing control unit 4b outputs a control signal to the NC signal generation unit 6 according to the masking state to control NC operation. The control of the NC operation includes on/off of the NC process, control for selection of the driver 2 outputting the NC signal, and others. For example, the sound processing control unit 4b determines which of the drivers 2 can output an NC signal S2 maximizing an NC effect for the arriving noise, and transmits a command to the NC signal generation unit 6.

Moreover, the sound processing control unit 4b performs a process for transmitting notification information SS to the host device 100 corresponding to an external device according to a determination result of the masking state, for example.

According to the first embodiment, the notification information SS includes quantization bit information necessary for the content sound data CT. For example, the quantization bit information contains information associated with a channel and a band corresponding to targets for reduction of the number of quantization bits in the content sound data CT.

The ambient sound type determination unit 5 performs a process for determining a sound type of the ambient sound data obtained by the microphones 3. Note that the determination of the type is not necessarily limited to determination of a specific sound type, and may be determination of whether or not the sound is handled as noise.

In addition, the ambient sound type determination unit 5 is chiefly required for processes in a second embodiment, and therefore may be eliminated from the processes in the first embodiment. However, a process for executing or not executing NC processing according to the sound type of the ambient sound data S1, for example, may be performed in the first embodiment.

The NC signal generation unit 6 is a function of generating the NC signal S2 for cancelling the ambient sound data obtained by the microphones 3 and designated as noise. For example, the NC signal S2 is generated by a process following an FF-NC algorithm.

The output signal generation unit 7 is a function of generating signals output from the drivers 2. The output signal generation unit 7 basically generates signals for driving the drivers 2 of the respective channels on the basis of data of the respective channels of the content sound data CT. Note that these signals include equalizer processing or the like for the content sound data CT in some cases.

Moreover, the output signal generation unit 7 generates a signal for driving the driver 2 of the designated channel on the basis of the NC signal S2 input to the output signal generation unit 7. Note that the channel of the driver 2 to which the NC signal is output is designated by the sound processing control unit 4b as described above in some cases.

A masking determination process performed by the determination unit 4 will be hereinafter described.

The masking effect is classified into some types. For example, these types include “same-time masking (frequency masking)” for blocking adjoining frequency sounds produced at the same time, and “time masking” for blocking sounds immediately before and immediately after.

Chiefly used in the present disclosure are the “same-time masking” described above, and “space masking” caused by a difference in sound arrival direction.

The “space masking” is such a phenomenon that a maximum masking effect is exerted in a state of the same arrival direction of a master and a maskee as viewed from a hearing person, and decreases in a state of different arrival directions. Note that FIG. 3 schematically illustrates a state of different arrival directions of a noise AN as an ambient sound, and a content sound AC.

According to the first embodiment, the noise AN is designated as an ambient sound.

In addition, concerning the noise AN, and the content sound AC output from the headphone 1 via the drivers 2, following cases are considered to occur from viewpoints of a masker-maskee relation, and arrival directions of the respective sounds.
The noise AN masks the content sound AC (sounds corresponding to all quantization bits, or a part of the quantization bits) by the same-time masking effect.
The content sound AC masks the noise AN.
The arrival directions of the noise AN and the content sound AC are the same (masking effect: large).
The arrival directions of the noise AN and the content sound AC are different (masking effect: small).

Improvement of the S/N, enhancement of a sense of sound separation, enhancement of the NC effect, and the bit rate reduction during viewing and hearing of the stereoscopic sound content are achieved by an appropriate combination of these cases.

Following three points concerning prerequisite phenomena and effects will be touched upon herein.
Driver position and NC effect
Minimum hearing limit and same-time masking
Space masking

A driver position and an NC effect will be initially described.

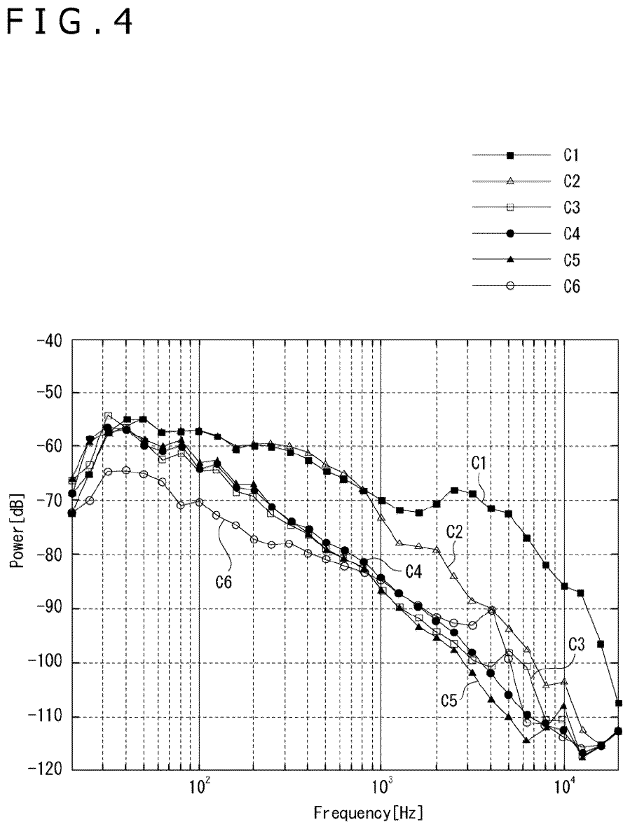

FIG. 4 illustrates an experimental result for presenting selection of a driver and NC performance of a multidriver headphone. Adopted in this experiment is a multidriver headphone equipped with four drivers No. 1 to No. 4.

In FIG. 4, the horizontal axis represents a frequency, and the vertical axis represents a sound pressure level. In this case, a downward direction of the vertical axis indicates more quietness, i.e., a higher NC effect.

A measurement result C1 indicates a sound pressure at an eardrum position in a state where the headphone is not attached.

A measurement result C2 indicates a sound pressure at the eardrum position in a state where the headphone is only attached (NC processing: off).

A measurement result C3 indicates output of NC signals from the driver designated as No. 1. A measurement result C4 indicates output of NC signals from the driver designated as No. 2. A measurement result C5 indicates output of NC signals from the driver designated as No. 3. A measurement result C6 indicates output of NC signals from the driver designated as No. 4.

According to the measurement result C6, the NC effect increases in a low band, but decreases in a range of 4 kHz or higher.

Meanwhile, it is recognizable that the NC effect of the measurement result C5 in a low band is smaller than the NC effect of the measurement result C6 but is particularly large in a range from 1 to 6 kHz. Similarly, each of the measurement results C3 and C4 has characteristics different from those of the other measurement results.

As obvious from the measurement results C3, C4, C5, and C6 obtained from NC processing using the different driver for each, concerning the noise cancelling by the multidriver headphone, the band exhibiting a large NC effect and the band exhibiting a small NC effect are produced depending on selection of the driver outputting NC signals. This difference comes from the positions of the respective arranged drivers, and attributes up to the eardrum.

In other words, these characteristics allow selection of a band for which the noise cancelling is intensively applied, according to selection or combination of the driver for outputting NC signals. This point is considered to be an advantage of noise cancelling by the multidriver headphone.

A minimum hearing limit and same-time masking (frequency direction) will be subsequently described. The minimum hearing limit indicates a limit of a sound pressure level of hearing by a human in each band. It is impossible to hear sound lower than the minimum hearing limit.

The same-time masking is a phenomenon characterized as follows. When a certain frequency component (F1) reaches the eardrum to be heard thereat, a frequency component (F2) around the frequency component (F1) is heard only in a case where the frequency component (F2) is higher than the frequency component (F1) to some extent and not masked by the frequency component (F1).

Considering these points, a part corresponding to accuracy of masking, and a part lower than the minimum hearing limit allow quantization errors. Accordingly, reduction of the transmission bit rate is achievable.

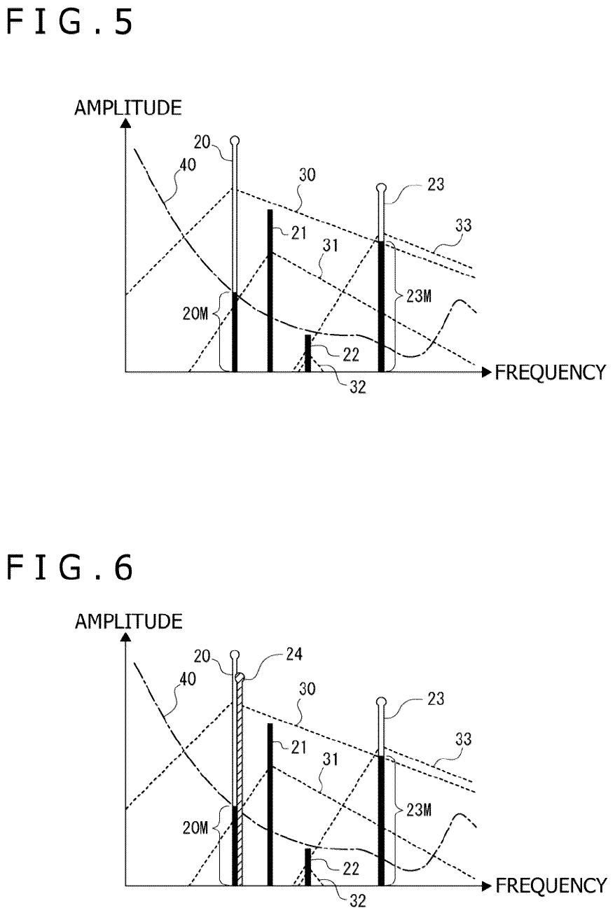

This point will be explained with reference to FIG. 5. The horizontal axis represents a frequency, while the vertical axis represents an amplitude.

In the figure, a minimum hearing limit 40 is indicated by a one-dot chain line.

In addition, the figure illustrates frequency components 20, 21, 22, and 23 of sounds generated at the same time. Moreover, each of masking levels 30, 31, 32, and 33 which are same-time masked by the frequency components 20, 21, 22, and 23, respectively, is indicated by a broken line.

Sound lower than the masking level 30 is masked by a sound of the frequency component 20. The masking level 30 has a vertex corresponding to a frequency of the frequency component 20, and expands toward other frequencies in an umbrella shape. Specifically, a sound at a frequency close to the frequency component 20 is easily masked even in a case where this sound is a relatively large sound. Masking becomes more difficult to achieve as a difference in frequency from the frequency component 20 increases.

A similar tendency is exhibited for each of the masking level 31 of the frequency component 21, the masking level 32 of the frequency component 22, and the masking level 33 of the frequency component 23.

According to the example in FIG. 5, the level of the frequency component 22 is lower than the minimum hearing limit.

The frequency component 21 is lower than the masking level 30 of the frequency component 20, and therefore is masked by the frequency component 20.

A portion corresponding to a region 23M in the frequency component 23 is masked by the frequency component 20.

A region 20M of the frequency component 20 is lower than the minimum hearing limit.

In this case, the regions 20M and 23M and the whole of the frequency components 21 and 22 each blacked out in the figure correspond to sound components masked or lower than the minimum hearing limit. Accordingly, these portions may be considered as portions not requiring highly accurate information.

In this manner, a region not requiring quantization accuracy can be determined according to determination of a masking state of emitted sound. Accordingly, when the determination unit 4 transmits to the host device 100 information associated with a channel and a band corresponding to targets of reduction of the number of the quantization bits in the content sound data CT on the basis of determination of the masking state, the host device 100 controls the quantization process for the content sound data CT and achieves reduction of the transmission bit rate.

Various types of cases will be hereinafter presented in a manner similar to the manner of FIG. 5.

FIG. 6 illustrates a state containing a noise in FIG. 5. For example, this is a case where a noise 24 having a single frequency is applied to an environment where content sounds having the frequency components 20, 21, 22, and 23 illustrated in FIG. 5 are heard.

According to the case in FIG. 6, the noise 24 exceeds a level of the same-time masking by the frequency component 20. Accordingly, the content sound is deteriorated.

In such a situation, NC processing is carried out to attempt cancelling of the noise 24 to a level equal to or lower than the same-time masking.

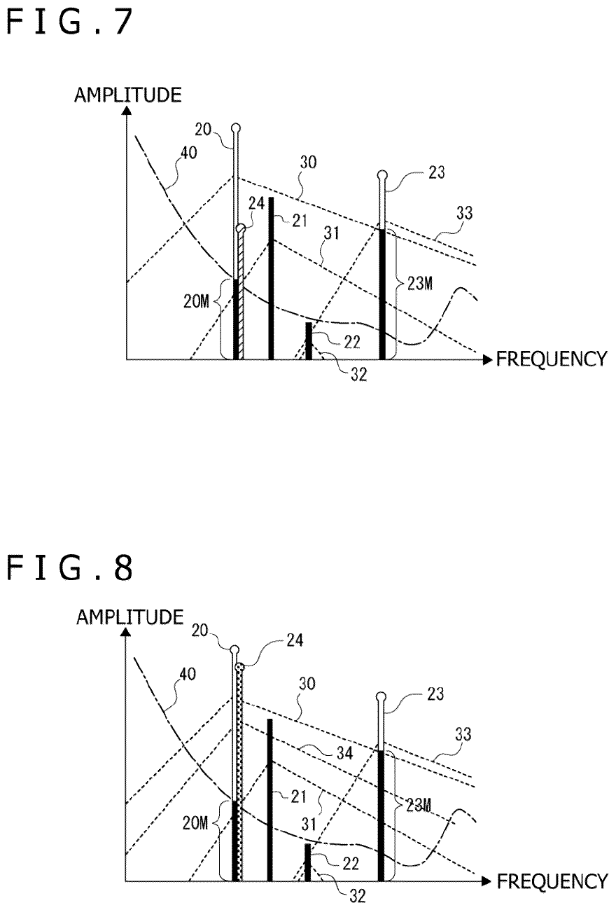

Similarly to FIG. 6, FIG. 7 illustrates a case where the noise 24 having a single frequency is applied to an environment where content sounds having the frequency components 20, 21, 22, and 23 illustrated in FIG. 5 are heard. In the case of FIG. 7, however, the noise 24 is originally at a level equivalent to or lower than the masking level 30 of masking by the frequency component 20 of the content sound. In such a case, NC processing need not be carried out.

FIG. 8 illustrates an example at the time when an uncancelled part of the noise 24 after NC processing exceeds the masking level 30 affected by the same-time masking of the content sound.

Accuracy of the low-order bits of the content sound is deteriorated by the noise 24, i.e., the uncancelled noise after the NC processing in this case. Specifically, this deterioration is caused in a part presented as regions included in the frequency components 20, 21, 22, and 23 and equal to or lower than the masking level 34 achieved by the noise 24.

Quantization errors in these regions are covered by the uncancelled noise 24 after the NC processing, and therefore correspond to a reduction target of the transmission bit rate.

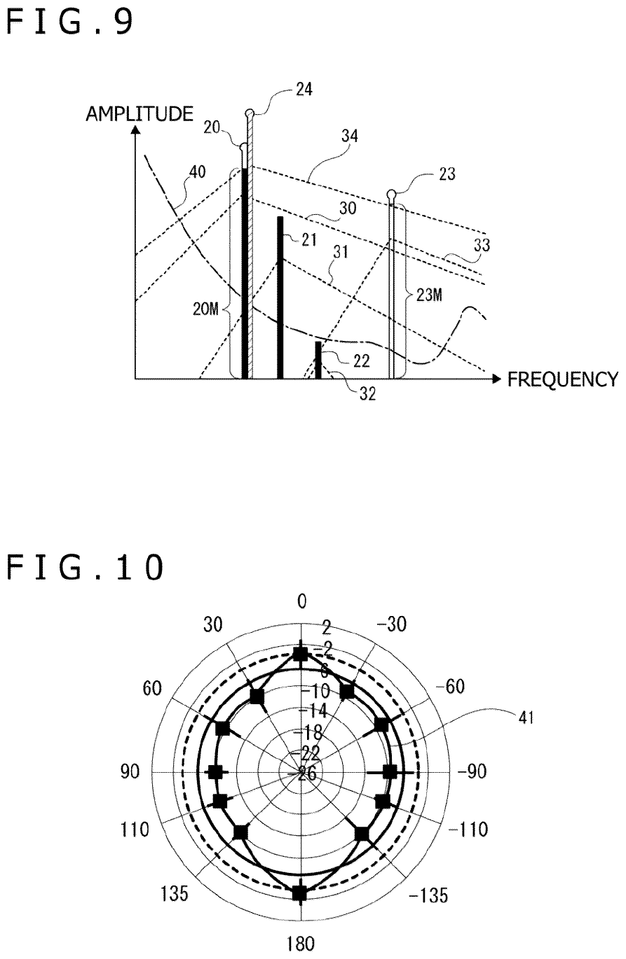

FIG. 9 illustrates an example case where the uncancelled noise 24 after NC processing is higher than the level of the content sound. A part presented as regions included in the frequency components 20, 21, 22, and 23 and equal to or lower than the masking level 34 achieved by the noise 24 is covered by the noise 24. Accordingly, an allowable range of quantization errors corresponding to the target of bit rate reduction is wider than that range in the case of FIG. 8.

Space masking will be subsequently described.

FIG. 10 illustrates an experimental result of the space masking. The front direction as viewed from the user (hearing person) is set to the 0-degree direction. FIG. 10 illustrates an experimental result obtained by shifting a maskee for each angle of 30 degrees with a masker located in the 0-degree direction.

As indicated by a curve 41, such a tendency is recognizable that a sound volume at which the maskee is not heard (masked) differs for each angle.

In comparison with the position of 0 degrees (the masker direction and the maskee direction are the same), masking is achieved at the position of 90 degrees only by the masker higher by approximately 6.4 dB or higher. Such a result has been therefore obtained that masking is not easily achieved in the presence of an angle difference.

According to the present embodiment, the three phenomena and effects, i.e., the driver position and the NC effect, the minimum hearing limit and the same-time masking, and the space masking as described above, are utilized.

First to fourth cases will be described.

Note that each of the content sound AC, the noise AN, the uncancelled noise AN (NC), and an NC sound ANC is schematically indicated by an arrow in each of FIGS. 11 to 26.

Each of the arrows represents an arrival direction of the sound reaching the eardrum 201. A thickness of each of the arrows indicates loudness of the sound.

Moreover, the reference numbers of the drivers 2 (2A, 2B, and up to 2(N)), and the microphones 3 (3A, 3B, and up to 3(M)) are eliminated from each of FIGS. 11 to 26 to give priority to easy understanding of the figures. It should be understood that the drivers 2 and the microphones 3 have configurations similar to those in FIGS. 2 and 3.

### First Case: Arrival Directions of Noise and Content Sound are the Same

FIG. 11 illustrates an example case where the arrival directions of the noise AN, which is designated as a masker, and the content sound AC are the same.

Incidentally, because this description is only explanation for the purpose of a basic idea of the embodiment, following conditions are assumed. The content sound has one channel, the noise has a single direction, and a loudness relation is the same for the entire bands.

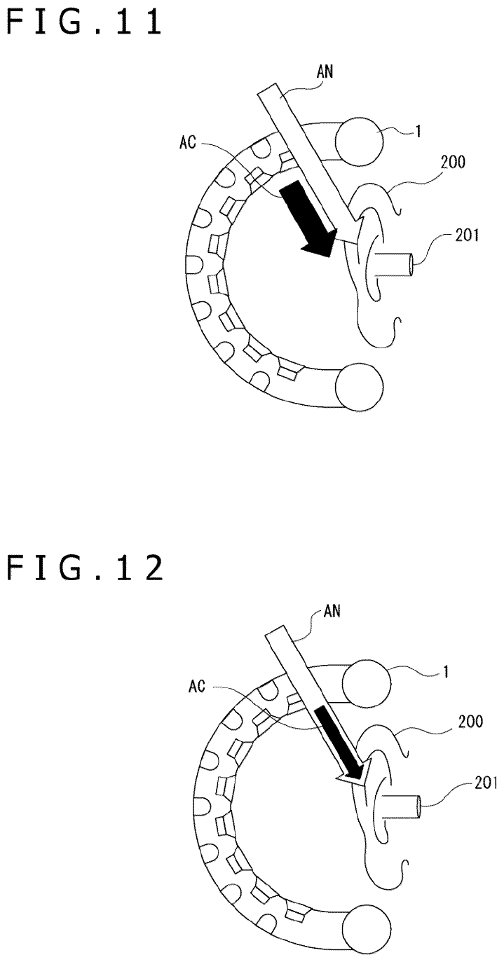

FIG. 12 illustrates a state where the noise AN masks the content sound AC.

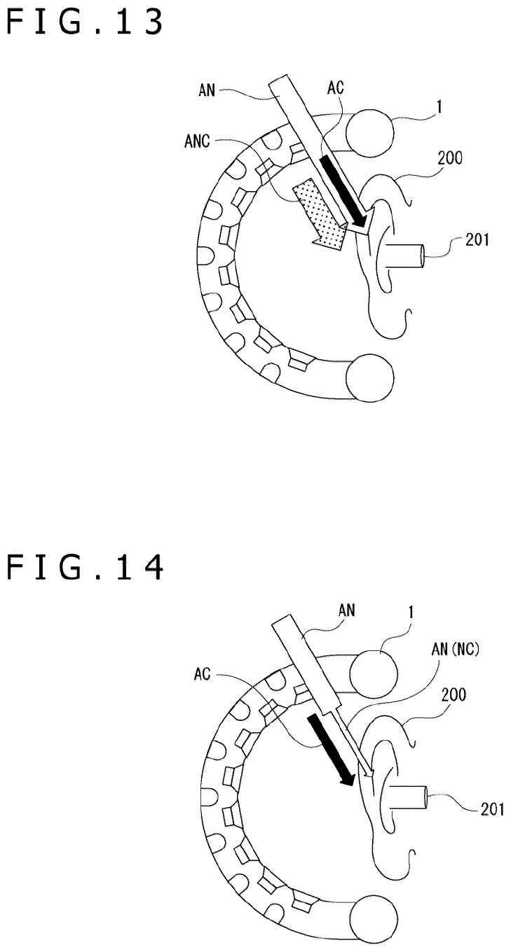

NC processing is performed for the state where the noise AN masks the content sound AC. In this manner, the content sound AC can be heard more clearly. Basically, it is effective for achieving the NC effect to carry out the NC processing by using the driver 2 located in the same direction as the noise arrival direction. Accordingly, the driver corresponding to the noise arrival direction is selected and caused to output the NC sound ANC. FIG. 13 illustrates a state where the NC sound ANC is output from the driver 2 located in the noise arrival direction.

In this case, the noise AN reaching the eardrum is difficult to completely cancel by using the NC sound. FIG. 14 illustrates a state where the uncancelled noise AN (NC) is present. Incidentally, while FIG. 14 is an illustration of such a state where the noise AN is cancelled from the position of the driver 2, this manner of illustration is only for convenience of depiction in the figure. The noise AN is actually cancelled at the position of the eardrum 201. This is applicable to illustrations of the uncancelled noise AN (NC) in other figures.

Concerning the uncancelled noise AN (NC), following cases (A) and (B) are assumed to occur.
(A) In a case where the uncancelled noise AN (NC) is larger than the minimum hearing limit and the quantization noise of the content signal, the uncancelled noise covers sounds corresponding to the quantization low-order bits of the content sound AC by the same-time masking effect. Accordingly, the quantization bits of the content sound data CT are reduced.
(B) In a case where the uncancelled noise AN (NC) disappears to an unperceivable level, or is masked by the content sound AC, the allocated bits in the transmission of the content sound data CT are maximized. However, bit reduction considering masking is carried out according to frequency characteristics of the content sound data CT.

Subsequently described will be a case where the arrival directions of the noise AN and the content sound AC are the same similarly to the above case. However, the content sound AC is designated as a masker in this case.

FIG. 15 illustrates a state where the noise AN is masked by the content sound AC. In a case where the content sound AC is a high-level sound and masks the noise AN, the noise AN is not perceived by a hearing person. Accordingly, NC processing need not be carried out.

The allocated bits in the transmission of the content sound data CT are maximized to achieve fineness recognizable for the user.

### Second Case: Arrival Directions of Noise and Content Sound are Different

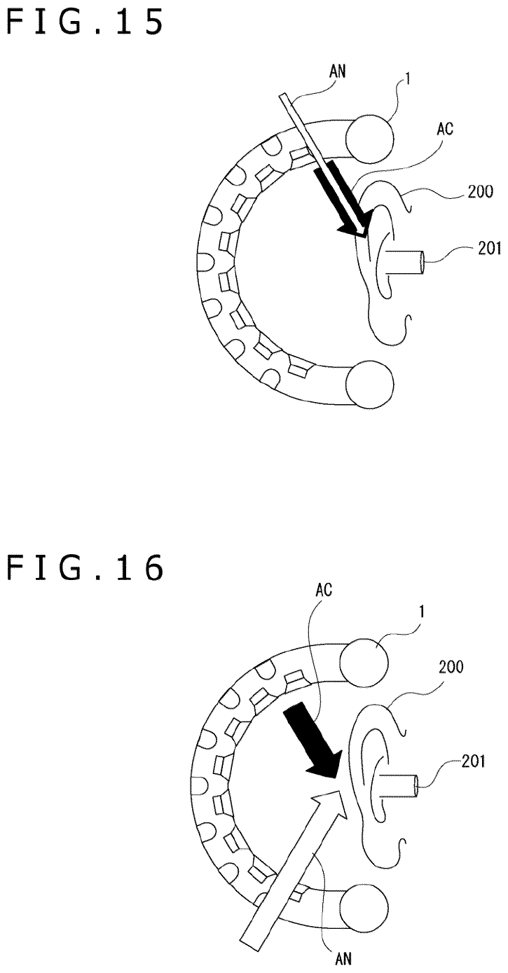

FIG. 16 illustrates a case where the arrival directions of the noise AN and the content sound AC are different.

Note that conditions in this case are similar to those of the first case. Specifically, the content sound has one channel, the noise has a single direction, and a loudness relation is the same in the entire bands.

Initially, suppose that the noise AN is a high-level noise.

Each of the content sound AC and the noise AN is easily heard by the space masking effect. In this case, the noise AN is more noticeable. Alternatively, when a level difference is sufficiently large, the noise AN completely masks the content sound AC.

Accordingly, the NC sound ANC is output by using the driver 2 suited for the arrival direction and the characteristics of the noise AN, and this makes it easier to hear the content signal. For example, as illustrated in FIG. 17, it is generally assumed that the NC sound ANC is output by using the driver 2 located in the same direction as the arrival direction of the noise AN.

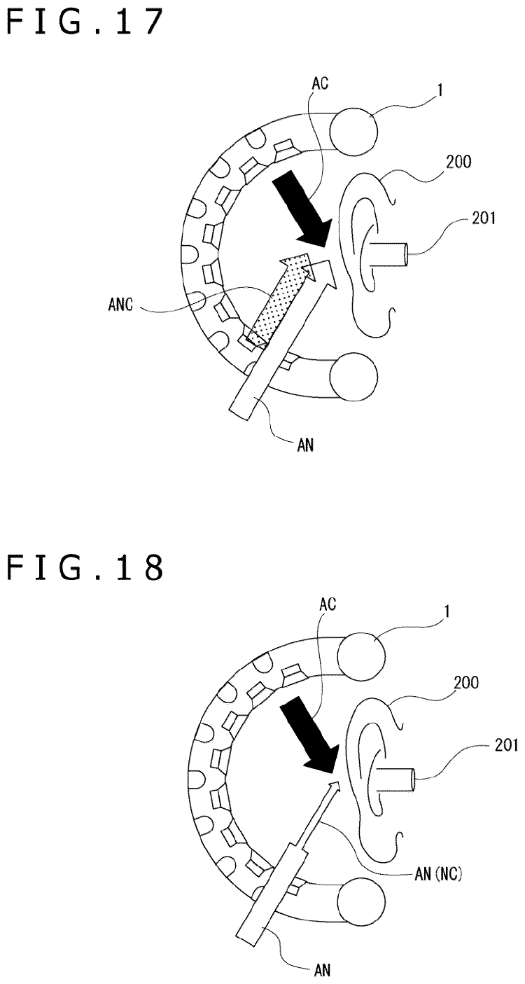

However, the uncancelled noise AN (NC) illustrated in FIG. 18 tends to be easily heard in the case of the different arrival directions. Specifically, the masking effect tends to decrease by the space masking effect. In this case, deterioration of the content sound AC resulting from bit reduction of the content sound data CT is easily recognizable.

Accordingly, determination is made in consideration of the space masking as well as the same-time masking explained with reference to FIGS. 5 to 9. For example, the masking levels (30, 31, 32, 33, 34) illustrated in FIGS. 5 to 9 may be shifted upward and downward according to an angle difference between the arrival directions.

### Third Case: The Arrival Directions of the Noises (Multiple Noises) are Contained in the Arrival Directions of the Content Sounds (Multiple Sounds)

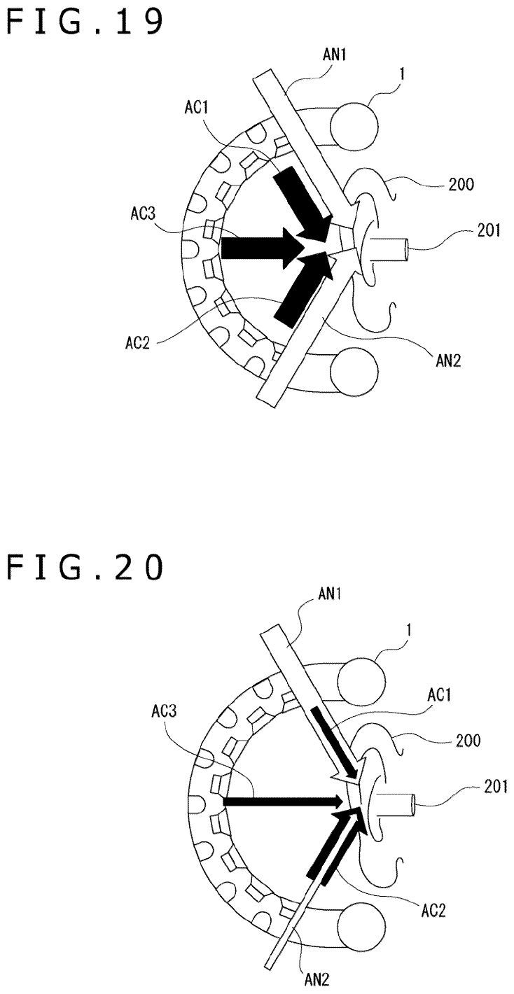

FIG. 19 illustrates an example of a third case. Each of content sounds AC1, AC2, and AC3 is output from the corresponding driver 2 as the content sound AC. Meanwhile, each of noises AN1 and AN2 arrives as the noise AN. The arrival directions of the noise AN1 and the content sound AC1 are the same, while the arrival directions of the noise AN2 and the content sound AC2 are the same.

When the noise AN is a high-level noise, NC processing is executed similarly to the first case. Moreover, the transmission bits of the content sound data CT are determined according to the uncancelled noise AN (NC) after the NC processing.

In a case where the multiple noises AN and the multiple content sounds AC are present herein, a relation between a masker and a maskee may vary for each direction as illustrated in FIG. 20.

According to the example illustrated in FIG. 20, the noise AN1 masks the content sound AC1. Meanwhile, the content sound AC2 masks the noise AN2.

Because the foregoing case is assumed to occur, it is determined which of the noise AN and the content sound AC becomes the masker for each of the arrival directions.

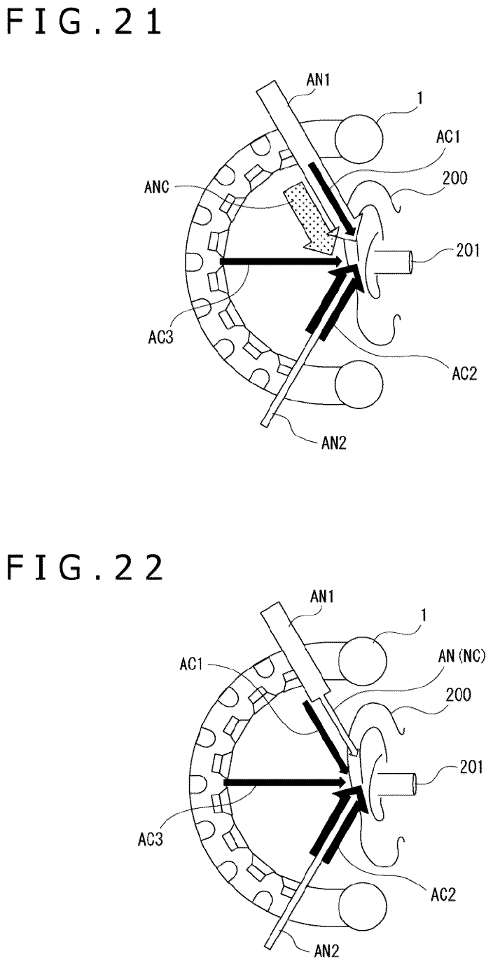

In a case where the level of the noise AN is higher than the level of the content sound AC, NC processing is performed for the noise AN. For example, FIG. 21 illustrates a state of output of the NC sound ANC from the driver 2 in the same direction in a case where the noise AN1 masks the content sound AC1.

Moreover, FIG. 22 illustrates the uncancelled noise AN (NC) resulting from this NC processing. For the uncancelled noise AN (NC), the processing described in (A) or (B) of the first case is only required to be performed.

Meanwhile, in a case where the level of the content sound AC is high to such an extent as to mask the noise AN, NC processing need not be performed for the noise AN.

For example, each of FIGS. 21 and 22 illustrates a state where the noise AN2 is masked by the content sound AC2.

Moreover, in the case of FIG. 19, the noise AN arriving in a certain direction may mask the content sound AC arriving in a different direction. This is such a case where the level of the noise AN1 is so high as to mask the content sound AC2, for example.

The NC processing is performed for the noise AN1. FIG. 21 illustrates a state where the NC sound ANC is output from the driver 2 in the same direction as the direction of the noise AN1, while FIG. 22 illustrates the uncancelled noise AN (NC).

In this case, the transmission bit allocation is determined for each of the content sounds AC1, AC2, and AC3 according to the blocked degrees of the content sounds AC1, AC2, and AC3 by the uncancelled noise AN (NC).

### Fourth Case: The Noises (Multiple Noises) Also Arrive in Directions Other Than the Arrival Directions of the Content Sounds (Multiple Sounds)

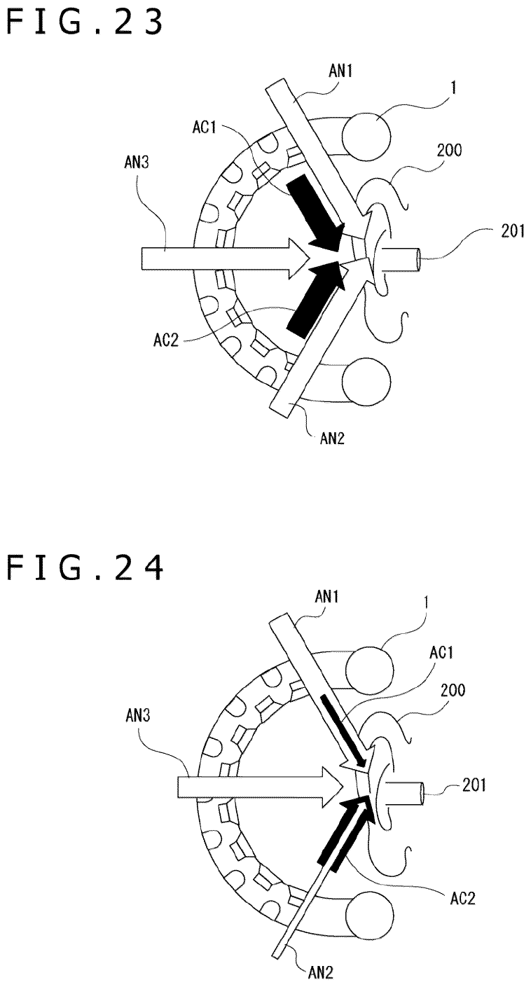

FIG. 23 illustrates an example of a fourth case. The content sounds AC1 and AC2 are output from the respective drivers 2 as the content sound AC. Meanwhile, the noises AN1, AN2, and AN3 arrive as the noise AN. The arrival directions of the noise AN1 and the content sound AC1 are the same, while the arrival directions of the noise AN2 and the content sound AC2 are the same. The noise AN3 is a noise arriving in a direction other than the arrival directions of the content sounds AC.

In this case, NC processing is carried out as necessary, and the transmission bits of the content sound data CT are determined according to the produced masking effect similarly to the third case.

According to the example illustrated in FIG. 23, the noise AN1 masks the content sound AC1 as illustrated in FIG. 24. Meanwhile, the content sound AC2 masks the noise AN2.

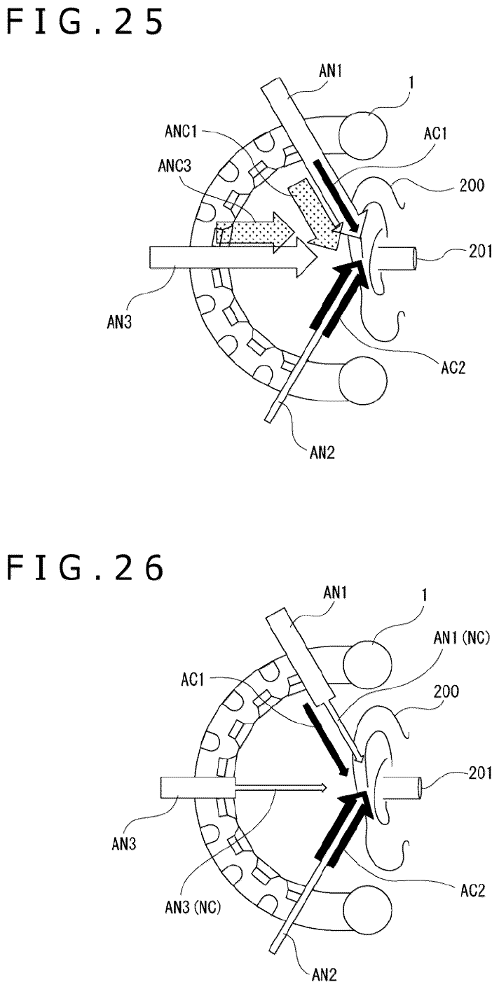

Accordingly, NC processing is performed for the noises AN1 and AN3. FIG. 25 illustrates a state where NC sound ANC1 and NC sound ANC3 are output from the driver 2 located in the same direction as the direction of the noise AN1 and the driver 2 located in the same direction as the direction of the noise AN3, respectively. FIG. 26 illustrates uncancelled noises AN1 (NC) and AN3 (NC).

In this case, the transmission bit allocation is determined for each of the content sounds AC1, AC2, and AC3 according to the blocked degrees of the content sounds AC1, AC2, and AC3 by the uncancelled noises AN1 (NC) and AN3 (NC).

The determination unit 4 (masking determination unit 4a and sound processing control unit 4b) in FIG. 1 controls NC processing performed by the NC signal generation unit 6 on the basis of the relation between the characteristics and the arrival directions of the noises AN, the characteristics of the content sounds AC, and the positions of the drivers 2 as in the manner described in the foregoing first to fourth cases. In other words, the determination unit 4 performs control of whether to carry out NC processing for each of the characteristics of the noises AN. Moreover, the determination unit 4 performs a process for determining sufficient allocations of the quantization bits to transmission of the content sound data CT according to the minimum hearing limit and the masking effect, and sending a request to the host device 100 on the basis of the determination.

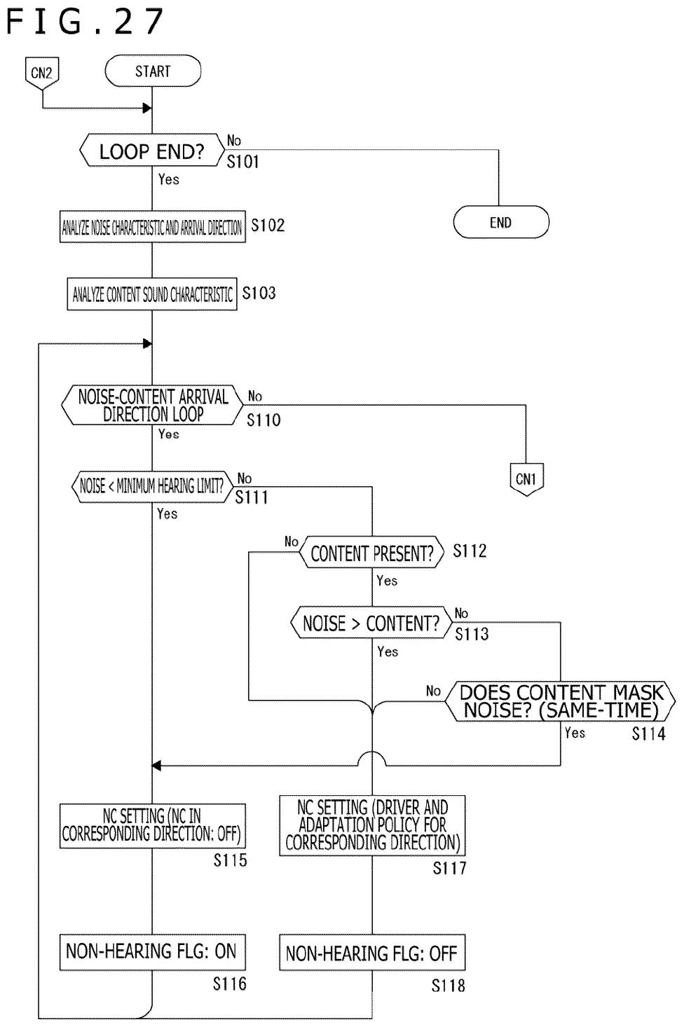

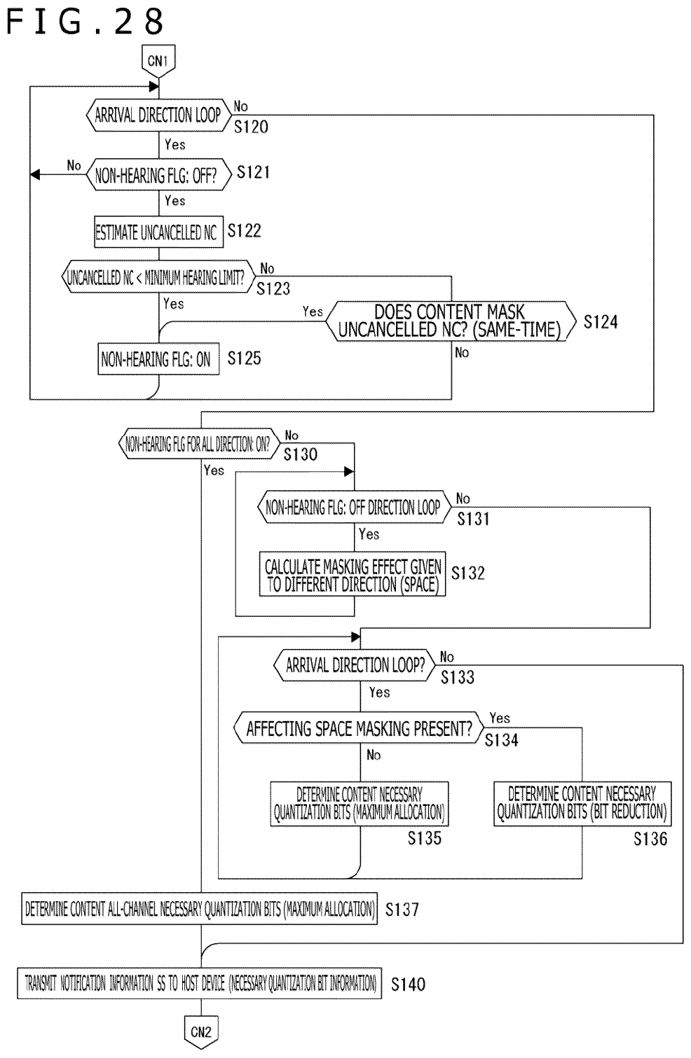

FIGS. 27 and 28 illustrate an example of this process performed by the determination unit 4.

Note that each of “CN1” and “CN2” in FIGS. 27 and 28 represents connection between flowcharts.

In a period when the headphone 1 receives the content sound data CT and outputs the content sounds AC from the drivers 2, the determination unit 4 repeats the process in FIGS. 27 and 28. Step S101 is a determination of whether to end this repetitive loop. For example, the process in FIGS. 27 and 28 ends in response to power off, an operation mode change, or the like.

During execution of the loop process, the determination unit 4 analyzes frequency characteristics and arrival directions of ambient sounds obtained by the microphones 3, i.e., the noises AN, in step S102.

Moreover, the determination unit 4 analyzes frequency characteristics of the content sound data CT in step S103. Note that the determination unit 4 can determine the arrival directions of the content sounds AC with respect to the user, i.e., which components of the sound are output, and which of the drivers 2 outputs the components, on the basis of the channel number of the content sound data CT.

In step S110, whether to continue or end a loop of processing from step S111 to step S118 is determined.

The processing from step S111 to step S118 is performed for each arrival direction. For example, the processing from step S111 to step S118 is carried out for each of first to Nth directions according to the number of channels of the drivers 2. After this processing is completed for all of the arrival directions, the loop ends.

In step S111, the determination unit 4 compares the noise AN coming in one certain direction with a minimum hearing limit. For the level of the noise AN, a part blocked by the housing of the headphone 1 is also taken into consideration.

In a case of (noise AN)<(minimum hearing limit), i.e., when all frequency components constituting the noise AN are lower than the minimum hearing limit, the determination unit 4 advances the flow to step S115 to set no necessity of NC processing for the corresponding noise AN.

Thereafter, the determination unit 4 sets a non-hearing flag to ON for the noise arriving in the direction of the current processing target in step S116.

In a case other than (noise AN)<(minimum hearing limit), the determination unit 4 advances the flow to step S112 to determine whether or not the content sound AC coming in the corresponding arrival direction is present.

If the content sound AC is absent, the determination unit 4 advances the flow to step S117 to set NC processing to ON. In addition, the determination unit 4 sets the driver 2 which is to output the NC sound ANC.

Thereafter, the determination unit 4 sets the non-hearing flag to OFF for the noise in the arrival direction of the current processing target in step S118.

In a case of determination that the content sound AC in this arrival direction is present in step S112, the determination unit 4 compares levels of the noise AN and the content sound AC output on the basis of the content sound data CT in step S113.

In a case where the level of the noise AN is higher than the level of the content sound AC, the determination unit 4 performs the processing in steps S117 and S118 described above.

In a case of determination that the level of the noise AN is equal to or lower than the level of the content sound AC, the determination unit 4 determines whether or not the content sound AC masks the noise by same-time masking in step S114. If the content sound AC does not mask the noise AN, the determination unit 4 performs the processing in steps S117 and S118 described above.

If the content sound AC masks the noise AN, the determination unit 4 performs the processing in steps S115 and S116 described above.

Settings of the NC processing are determined for each arrival direction by executing the foregoing process for each arrival direction. Specifically, the non-hearing flag is set to OFF for the direction requiring NC processing, and set to ON for the direction not requiring NC processing.

Thereafter, the determination unit 4 ends the loop in step S110, and advances the flow to step S120 in FIG. 28.

In step S120, whether to continue or end a loop of processing from step S121 to step S125 is determined. The processing from step S121 to step S125 is performed for each arrival direction similarly to above.

In step S121, the determination unit 4 checks the non-hearing flag for one arrival direction corresponding to a processing target. If the non-hearing flag is ON, i.e., no necessity of NC processing is set, the flow returns to step S120 for this arrival direction, and shifts to a process for the subsequent arrival direction.

If the non-hearing flag is OFF in step S121, the determination unit 4 advances the flow to step S122 to estimate frequency characteristics and a level of the uncancelled noise AN (NC) after the NC processing.

Thereafter, the determination unit 4 compares the uncancelled noise AN (NC) with the minimum hearing limit in step S123.

In a case of (uncancelled noise AN (NC))<(minimum hearing limit), i.e., when all frequency components constituting the uncancelled noise AN (NC) are lower than the minimum hearing limit, the determination unit 4 advances the flow to step S125 to set the non-hearing flag to ON for the corresponding uncancelled noise AN (NC).

In a case other than (uncancelled noise AN (NC)<(minimum hearing limit), the determination unit 4 advances the flow to step S124 to determine whether or not the content sound AC masks the corresponding uncancelled noise AN (NC) by same-time masking.

In a case where the content sound AC masks the uncancelled noise AN (NC), the determination unit 4 advances the flow to step S125 to set the non-hearing flag to ON for the corresponding uncancelled noise AN (NC).

In a case of determination that the corresponding uncancelled noise AN (NC) is not masked, the flow returns to step S120 while maintaining the setting of the non-hearing flag to OFF.

The uncancelled noise AN (NC) is estimated for each direction by performing the processing from step S121 to step S125 described above for each arrival direction. In a case where the uncancelled noise AN (NC) is smaller than the minimum hearing limit, or masked by the content sound AC, the non-hearing flag is changed to ON for the corresponding arrival direction.

After completion of the foregoing loop process, the determination unit 4 advances the flow from step S120 to step S130.

In step S130, the determination unit checks whether or not the non-hearing flag is ON for all the arrival directions.

If the non-hearing flag is ON for all the arrival directions, the determination unit 4 determines necessary quantization bits for all the channels of the content sound data CT in step S137. In this case, highly accurate content sound data CT is required. Accordingly, maximum allocations are requested as the number of the quantization bits.

In a case where the presence of the arrival direction of the non-hearing flag set to OFF is confirmed in step S130, the determination unit 4 advances the flow to step S131 to perform processing in step S132 for each arrival direction corresponding to the non-hearing flag set to OFF. In step S132, the determination unit 4 calculates a space masking effect given on a different direction by the corresponding direction. In this manner, the space masking effect on the different direction can be obtained for one or multiple arrival directions for which the non-hearing flag is set to OFF.

In step S133, the determination unit 4 determines whether to continue or end the loop for each arrival direction. Specifically, the processing from step S134 to step S136 is performed for each arrival direction.

In step S134, the determination unit 4 determines whether or not space masking affecting the arrival direction designated as a processing target is present.

In a case where no arrival direction as the processing target is affected by the space masking, the determination unit 4 advances the flow to step S135 to determine necessary quantization bits for the content sound data CT in the corresponding direction. In this case, highly accurate content sound data CT is required. Accordingly, maximum allocations are requested as the number of the quantization bits.

In a case where the arrival direction as the processing target is affected by the space masking, the determination unit 4 advances the flow to step S136 to determine necessary quantization bits for the content sound data CT in the corresponding direction. In this case, a region not requiring highly accurate information is produced by the masking. Accordingly, reduction of the number of the quantization bits is requested.

In the foregoing loop from step S133, the number of quantization bits is set for each arrival direction in either step S135 or step S136.

The number of quantization bits is set for each direction in step S135, S136, or S137. The number of quantization bits can be set for each channel by matching the respective directions corresponding to the targets of the loop process with the respective channels.

In step S140, the determination unit 4 transmits the notification information SS to the host device. In this case, the notification information SS contains information indicating the necessary number of quantization bits for each channel.

After completion of transmission of the notification information SS in step S140, the determination unit 4 returns the flow to step S101 in FIG. 27. Thereafter, the process described above is repeated.

According to the first embodiment described above, the determination unit 4 performs the process in FIGS. 27 and 28. Accordingly, transmission bits of content sound data are reduced according to situations to achieve reduction of transmission bit rates.

Moreover, which driver 2 of the headphone 1 is to be used to cancel the noise AN, or which driver 2 need not be used for NC processing is determined, and settings are sequentially changed according to this determination. In this manner, a more comfortable S/N of the content sound AC, a sense of sound separation, and improvement of the NC effect are achievable.

### 2. Second Embodiment

Chiefly described in the second embodiment will be a process for enabling the user to recognize ambient sounds. According to the first embodiment described above, ambient sounds are designated as the noise AN, and the necessary process is performed for these sounds. According to the second embodiment, however, a necessary process is performed for ambient sounds desired to be recognized by the user.

For example, following sounds are specific examples of these ambient sounds.
Sounds of cars or the like approaching from the back or the side
Sounds approaching the user's own room (the room of the user wearing the headphone 1) (footsteps etc.)
Announcement (announcement in public transportation, various public facilities, etc.)
Alerts, sirens (sounds of emergency vehicles, earthquake early warnings, etc.)
Voices calling the user (the user wearing the headphone 1)

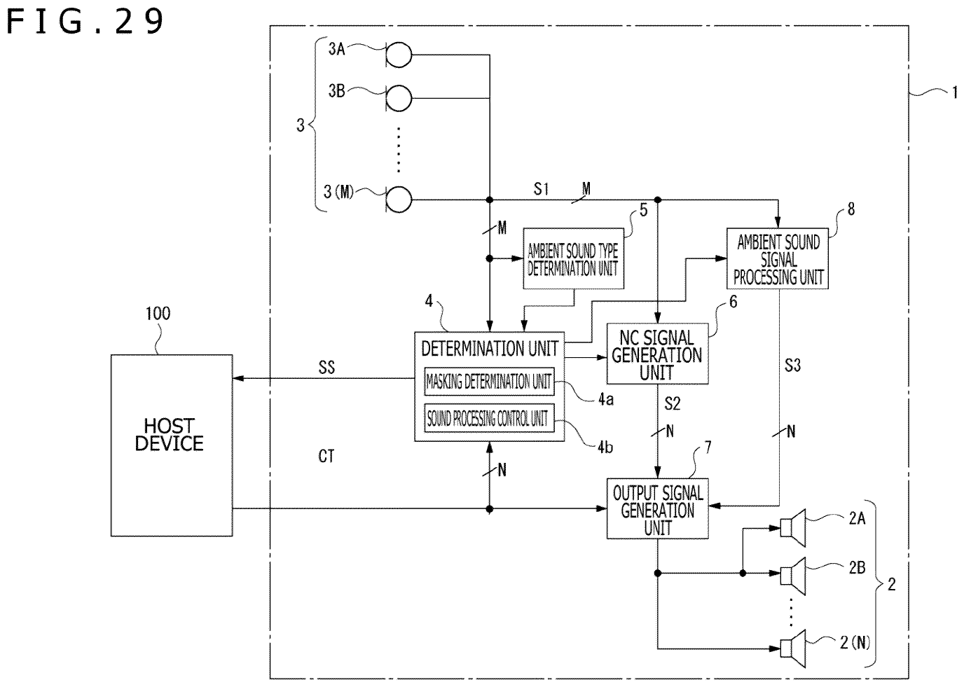

FIG. 29 illustrates a configuration example of the headphone 1. Note that parts identical to the corresponding parts in FIG. 1 are given identical reference signs to avoid repetitive explanation. The configuration in FIG. 29 is different from the configuration in FIG. 1 in that an ambient sound signal processing unit 8 is added.

The ambient sound signal processing unit 8 performs a process for the ambient sound data S1 obtained by the microphones 3 on the basis of control by the sound processing control unit 4b of the determination unit 4. For example, the ambient sound signal processing unit 8 performs processing such as noise reduction and sound emphasis for the ambient sound data S1, and outputs sound data S3 after the processing. Alternatively, the ambient sound signal processing unit 8 performs a process for generating the sound data S3 such as beep sounds and announcement voices in some cases.

The sound data S3 signal-processed or generated by the ambient sound signal processing unit 8 is supplied to the output signal generation unit 7. The output signal generation unit 7 generates signals to be output to the drivers 2 according to the designated channel on the basis of the sound data S3 together with the content sound data CT and the NC sound data S2.

The ambient sound type determination unit 5 performs a process for determining a sound type of the ambient sound data obtained by the microphones 3. For example, the ambient sound type determination unit 5 determines a specific sound type, such as sounds of approaching cars, footsteps, and announcement sounds of trains. Note that the determination of the type may be determination of whether or not the sounds are handled as noise, rather than determination of the specific sound type.

The determination unit 4 receives input of the ambient sound data S1 and the type information associated with the ambient sound data S1, and causes the masking determination unit 4a and the sound processing control unit 4b to perform processing.

The masking determination unit 4a determines a masking state on the basis of the relation between the ambient sound data S1 and the content sound data CT similarly to the first embodiment.

In this case, whether or not a necessary ambient sound is masked by the content sound AC is also determined on the basis of the type information.

The sound processing control unit 4b controls sound processing according to a determination result of the masking state obtained by the masking determination unit 4a.

For example, the sound processing control unit 4b outputs a control signal to the NC signal generation unit 6 according to the masking state to control NC operation. The control of the NC operation includes ON/OFF of NC processing, control for selection of the driver 2 outputting the NC signal, and others.

Moreover, the sound processing control unit 4b performs control for outputting a sound enabling recognition of the ambient sound from the driver 2 according to the sound type of the ambient sound data S1 and the determination result of the masking state.

In this case, the sound processing control unit 4b selects the channel of the driver 2 outputting the sound enabling recognition of the ambient sound according to the arrival direction of the ambient sound.

Furthermore, the sound processing control unit 4b controls the ambient sound signal processing unit 8 such that a sound based on the ambient sound obtained by the microphone 3, i.e., a sound produced by signal-processing the ambient sound data S1, is output from the driver 2 as the sound enabling recognition of the ambient sound.

Alternatively, the sound processing control unit 4b controls the ambient sound signal processing unit 8 such that a generated sound for enabling recognition of the ambient sound is output from the driver 2.

Moreover, the sound processing control unit 4b performs a process for transmitting the notification information SS to the host device 100 corresponding to an external device according to a determination result of the masking state, for example.

According to the second embodiment herein, the sound processing control unit 4b transmits information used for display enabling recognition of the ambient sound as the notification information SS. The information used for display enabling recognition of the ambient sound contains a part or all of information indicating the arrival direction of the ambient sound, information indicating the type of the ambient sound, and information indicating a determination result of the masking state in some cases.

According to the second embodiment described above, a following process is performed.

As obvious from the above examples, ambient sounds include sounds requiring recognition by the user. Accordingly, the ambient sound type determination unit 5 determines types of sounds.

The determination unit 4 (masking determination unit 4a) determines whether or not the ambient sound data S1 corresponds to a sound requiring recognition by the user on the basis of type information. If the ambient sound data S1 corresponds to a sound requiring recognition, the determination unit 4 determines a masked state of this sound by the content sound AC. The determination unit 4 also determines whether or not the sound is cancelled by NC processing.

In a case where the necessary ambient sound is masked or cancelled as noise, the sound is difficult to recognize by the user if no change is made. Accordingly, the determination unit 4 (sound processing control unit 4b) performs a process for enabling recognition of this ambient sound.

For example, the process for enabling recognition of the ambient sound is a process for outputting a sound.

For example, the determination unit 4 causes the ambient sound signal processing unit 8 to execute a process for allowing easy hearing of the ambient sound data S1, such as noise reduction and sound emphasis, and output a sound corresponding to the sound data S3 after the processing via the driver 2. In this case, the determination unit 4 may designate the driver 2 for outputting the sound on the basis of the arrival direction of the ambient sound.

In this manner, the user is allowed to hear the ambient sound itself in the arrival direction of the actual ambient sound while hearing the content sound AC.

Concerning the manner of outputting the sound, the sound to be output may be a sound indicating an alert such as a beep sound, or a message sound, rather than the ambient sound itself.

For example, the determination unit 4 causes the ambient sound signal processing unit 8 to execute a sound data generation process, and causes the driver 2 to output a sound based on the generated sound data S3, such as a beep sound and a message sound.

In this manner, the user is allowed to recognize the fact that any necessary ambient sound is generated while hearing the content sounds AC.

In this case, the determination unit 4 may also designate the driver 2 for outputting the sound on the basis of the arrival direction of the ambient sound. In this manner, the user is allowed to recognize the fact that a necessary ambient sound is arriving in an arrival direction of a beep sound or the like.

The beep sound is suited for a case where only notification of the presence of ambient sound is required.

Note that the driver 2 selected to output the ambient sound itself, the beep sound, or the message sound may be a driver of such a channel not affected by space masking achieved by the content sound AC, for example. In this manner, recognizability of the necessary ambient sound is allowed to improve.

Moreover, there is such a case where the user can recognize the type of the ambient sound on the basis of output of the ambient sound itself but cannot recognize the type of the sound on the basis of the beep sound or the message sound. Accordingly, the contents of the message, or the sound quality or the sound volume of the beep sound may be changed according to the type and urgency. In this manner, the warning level can be raised, or the type of the ambient sound can be recognized.

For example, the message sound may contain specific contents, such as “a car is approaching from the back,” and “someone is approaching the room.”

Furthermore, determination criteria may be varied according to the size of a road where the user is walking (or running), or crowdedness with cars on the road on the basis of GPS position information combined with the foregoing information, and a notification may be issued according to a determination.

For recognizing the ambient sound, a notification by display on the host device 100 may be presented instead of or in addition to the sound output from the headphone 1 described above. Specifically, the determination unit 4 sends a determination result to the host device 100 constituted by a device such as a smartphone and an HMD, and the host device 100 notifies the user of the determination result.

During viewing and hearing game content, video content, or the like, the user is gazing at the screen of the host device. Accordingly, it is preferable that the notification of the ambient sound is presented by message display or the like on the screen.

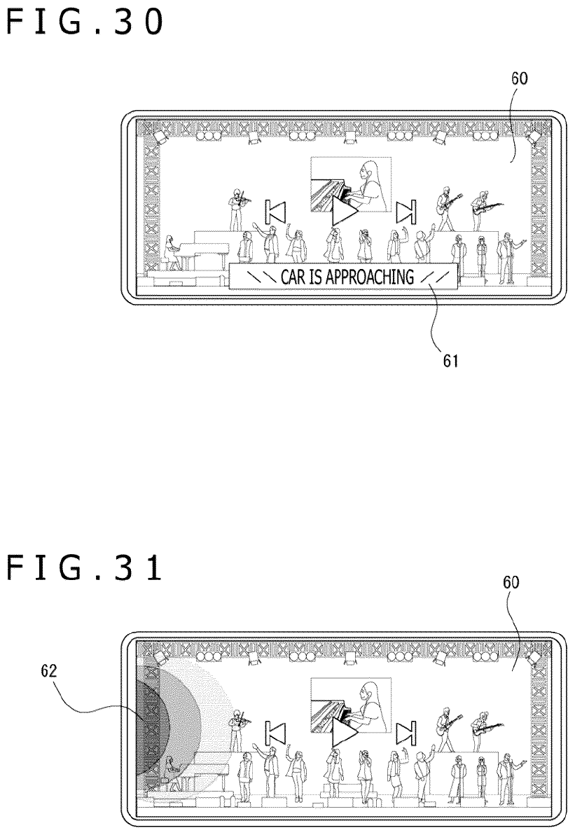

For example, FIG. 30 illustrates an example of display of a message 61 on a screen 60 of the host device 100.

The display position of the message 61 illustrated in the figure may be varied according to the arrival direction of the ambient sound. For example, the message 61 saying “car is approaching” may be displayed at a lower position on the screen as illustrated in FIG. 30 if the car is approaching from the back. In addition, the message 61 may be displayed at an upper position or at the center of the screen, on the left, and on the right if the car is approaching from the front, the left, or the right, respectively, for example.

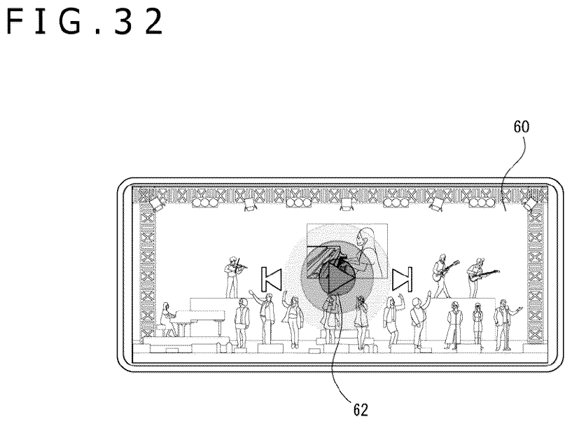

As illustrated in FIGS. 31 and 32, an effect image 62 may be presented on the screen 60 by an alternative method. In this case, the effect image 62 may be presented according to the arrival direction of the ambient sound similarly to the above case. FIG. 31 illustrates a case of a sound coming from the left, while FIG. 32 illustrates a case of a sound from the front.

The size of the effect image 62 may be varied to express the volume of the ambient sound.

The ambient sound can be handled by the notification presented by these types of display during viewing and hearing of a video, game play such as VR (Virtual Reality), or other occasions. For example, when footsteps approaching the room of the user are masked and difficult to hear, this process is performed to enable the user playing a game to take an appropriate action, such as suspension of the game, on the basis of the notification.

Note that the notification may be presented by vibrations or the like on the host device 100 side or the headphone 1 side in addition to the notification by display described above. Moreover, both the notification by display and the sound from the headphone 1 as described above may be used.

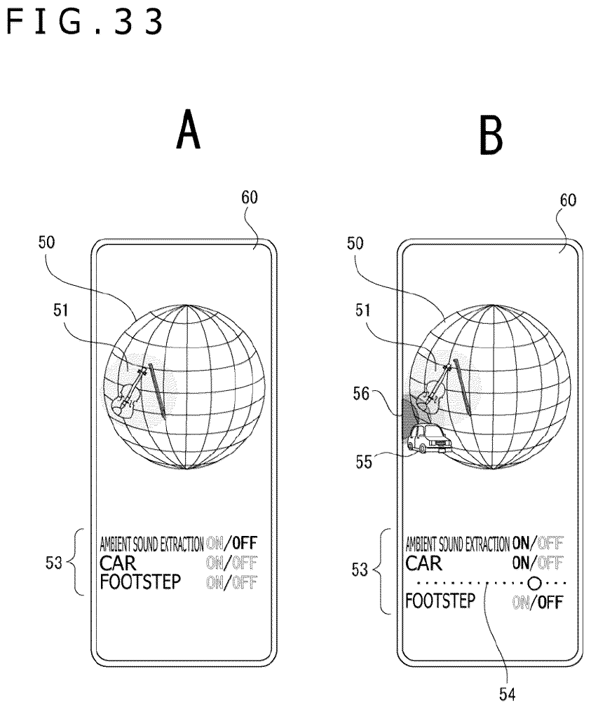

Each of FIGS. 33, 34, and 35 illustrates an example of a notification about a more detailed situation of an ambient sound by using screen display.

In each of the figures, an image of a space around the head of the user is displayed in the form of space coordinates 50. A content sound image 51, ambient sound type images 55 and 57, and effect images 56 and 58 are displayed at positions corresponding to arrival directions of sounds on the basis of the space coordinates 50.

The content sound image 51 is an image indicating the type and the masking range of the content sound AC. According to the case in FIG. 33A, a sound of a musical instrument such as a violin is localized on the left side of the user, and a masked range of other sounds by the sound of this musical instrument is indicated in a circular shape.

Each of the ambient sound type images 55 and 57 is an image indicating the type of the ambient sound, and presenting an image of a car, an image of footprints indicating footsteps, and the like, for example. Each of the effect images 56 and 58 represents an ambient sound.

Each of the sizes of the ambient sound type images 55 and 57, and the sizes of the effect images 56 and 58 indicates a masked volume by the ambient sound. Moreover, each of the display positions of the ambient sound type images 55 and 57 and the effect images 56 and 58 indicates an arrival direction of the ambient sound.

Furthermore, a setting section 53 is displayed on the screen 60. The setting section 53 is an operation section through which the user inputs any settings concerning ON/OFF of notification functions.

For example, setting fields of “ambient sound extraction ON/OFF,” “car ON/OFF,” and “footstep ON/OFF” are prepared for the setting section 53.

FIG. 33A illustrates a state where ambient sound extraction is turned off. In this case, the content sound image 51 is displayed.

FIG. 33B illustrates a state where the car is turned on as a type of the ambient sound under the ON-condition of ambient sound extraction. When the car is turned on, a slide bar 54 is displayed. The user is allowed to set an extraction level by using the slide bar 54.

Thereafter, when a sound of the car is detected, the ambient sound type image 55 and the effect image 56 are displayed according to the arrival direction of the sound of the car, and a volume masked by the sound as illustrated in FIG. 33B. In the display presented in this case, the direction of the sound of the car and the direction of the content sound are the same direction, and a certain volume of the sound is masked.

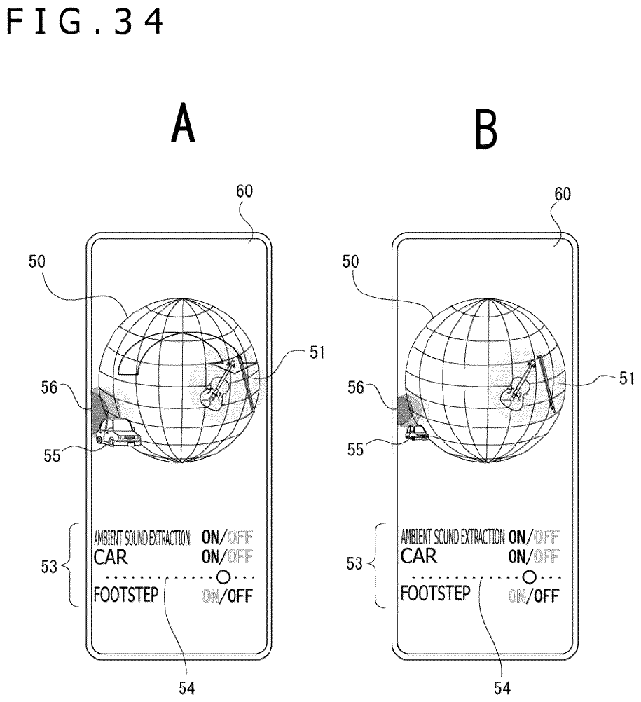

FIG. 34A illustrates a case where the content sound has shifted. Examples of this case include a case where localization is variable in original contents of the content sound data CT, and a case where the user performs operation for changing the localization of the musical instrument.

Alternatively, there is a possibility that the determination unit 4 requests the host device 100 to automatically change the localization of the musical instrument. For example, the determination unit 4 requests the host device 100 to change the localization of the content sound in response to a masked state of the sound of the car. In response to this request, the host device 100 changes the channel of the content sound data CT to change the localization.

When the localization is changed as illustrated in FIG. 34A, the masked volume decreases by the space masking effect. Accordingly, the user can easily hear the sound of the car. As illustrated in FIG. 34B, each of the sizes of the ambient sound type image 55 and the effect image 56 is reduced by an amount corresponding to the decrease in the masked volume.

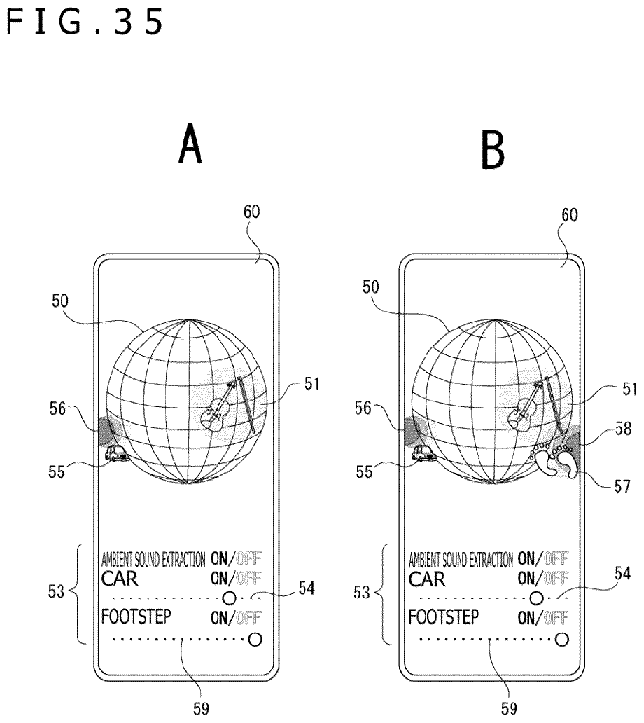

FIG. 35A illustrates a case where footsteps are designated as an extraction target by the setting section 53. In this case, a slide bar 59 is similarly displayed by turning on the footsteps. The user is allowed to set an extraction level of the footsteps by using the slide bar 59.

FIG. 35B illustrates a case where footsteps arriving from the right side have been detected. In response to this detection, the ambient sound type image 57 indicating footsteps, and the effect image 58 are displayed on the right side. Illustrated in this example is such a state where a certain degree of the footsteps is masked by the content sound.

By presenting the display as illustrated in FIGS. 33 to 35, the user is enabled to recognize more detailed ambient sounds and a masked state of the ambient sounds.

While described above has been the example of stereoscopic sound content, a game or the like has a sound source whose position automatically moves, for example. The moving position of the sound source is followed in real time to analyze a masking effect, and NC processing and transmission bit rate setting of the content sound data CT are appropriately performed.

If an HMD constituting the host device 100 and the headphone 1 are combined, the directions of the visual perception and the auditory perception of the user agree with each other. Accordingly, this is a highly compatible combination. When the direction of the head of the user changes, the position of the headphone 1 (microphones 3) also naturally changes at the same time. Accordingly, a shift of an ambient sound source as viewed from the user can be followed in real time by a change of signals from the microphones 3.

While illustrated in each of FIGS. 33 to 35 is an image of such a case where stereoscopic sound content is present, the display illustrated in each of FIGS. 33 to 35 may be presented for content other than stereoscopic sound, or in a silent state including no content.

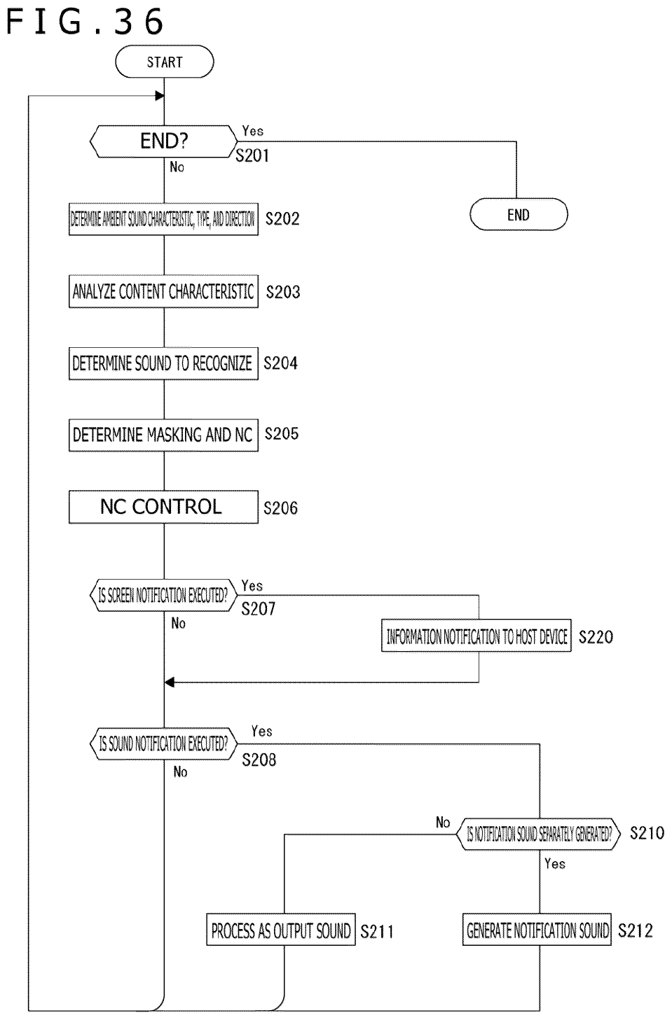

Described in the second embodiment have been such cases where a notification of a necessary ambient sound is issued using voices or display. FIG. 36 illustrates a processing example performed by the determination unit 4 to achieve this operation.

In a period when the headphone 1 receives the content sound data CT and outputs the content sound AC from the driver 2, the determination unit 4 repeats a process in FIG. 36. Step S201 is a determination of whether to end repetition of this loop. For example, the process in FIG. 36 ends in response to power off, an operation mode change, or the like.

In the loop period, the determination unit 4 analyzes frequency characteristics and arrival directions of ambient sounds obtained by the microphones 3, i.e., the noise AN, in step S202. Moreover, the determination unit 4 determines the types of the sounds on the basis of type information received from the ambient sound type determination unit 5.

The determination unit 4 analyzes frequency characteristics of the content sound data CT in step S203. Note that the arrival direction of the content sound AC can be determined on the basis of the channel number of the content sound data CT.

In step S204, the determination unit 4 determines the presence or absence of a sound requiring recognition by the user in the ambient sounds. In a case where a sound such as a sound of a car, footsteps, an announcement, and an alert is present on the basis of the ambient sound type determination result, it is determined that a sound requiring recognition by the user is present. In this case, frequency characteristics and an arrival direction of this sound are determined.

In step S205, the determination unit 4 determines whether to execute masking state determination and NC processing.

The determination unit 4 determines a masking state on the basis of a relation between the ambient sound and the content sound similarly to the first embodiment. Thereafter, the determination unit 4 determines whether to execute NC processing according to the masking state.

Moreover, the determination unit 4 also determines whether to execute NC processing on the basis of the presence or absence of a sound requiring recognition by the user in the ambient sounds.

For example, in a case where no sound requiring recognition by the user is contained in the ambient sounds, the determination unit 4 determines that ordinary NC processing is to be executed for the ambient sounds.

In a case where any sound requiring recognition by the user is contained in the ambient sounds, the determination unit 4 determines that NC processing is to be executed for at least frequency components other than the corresponding sound, and not to be executed for the sound requiring recognition. Note that ordinary NC processing may be performed in this case. For example, for generating beep sounds and message sounds, NC processing for the ambient sounds may be constantly executed.

In a case where only the sound requiring recognition by the user is contained in the ambient sounds (or the sound requiring recognition is dominant), NC processing is determined not to be executed. Note that ordinary NC processing may be performed in this case similarly to the above case.

In step S206, the determination unit 4 controls the NC signal generation unit 6 on the basis of the determination result in step S205. For example, the determination unit 4 issues an instruction of whether to perform NC processing. This control includes invalidation of NC processing for only particular frequency components in some cases. The determination unit 4 also designates the channel of the driver 2 which outputs an NC sound.

In step S207, the determination unit 4 branches the process on the basis of whether to issue a notification to the user by display on the host device 100. For example, in a case where the ambient sounds contain a sound requiring recognition by the user in the ON-state of the notification by display, the flow proceeds to step S220 to transmit the notification information SS to the host device 100. The notification information SS contains information indicating the type, the arrival direction, and a masked level of the ambient sound. Accordingly, the display explained with reference to FIGS. 30 to 35 is achievable on the host device 100.

In step S208, the determination unit 4 branches the process on the basis of whether to issue a notification by a sound. For example, in a case where a sound requiring notification by the user is contained in the ambient sounds, the determination unit 4 advances the flow to step S210 to branch the process according to the manner of the ON-state of the notification.

In a case of output of the ambient sound itself, the determination unit 4 advances the flow to step S211, and instructs the ambient sound signal processing unit 8 to execute noise reduction, sound emphasis, or the like for the ambient sound data S1. Moreover, the determination unit 4 designates the channel of the driver 2 for output according to the arrival direction.

In a case of generation of a notification sound, the determination unit 4 advances the flow to step S212 to instruct the ambient sound signal processing unit 8 to generate beep sounds or message sounds. Moreover, the determination unit 4 designates the channel of the driver 2 for output according to the arrival direction.

For example, the operation for issuing a notification of the ambient sound with the sounds or display described above is achieved by repeating the foregoing process illustrated in FIG. 36.

### 3. Summary and Modifications

According to the first and second embodiments described above, following advantageous effects are offered.

The signal processing device according to the embodiments is implemented as a processor or the like which has the function of the determination unit 4 including the masking determination unit 4a and the sound processing control unit 4b. In addition, the sound output device according to the embodiments is implemented as the headphone 1 including the determination unit 4 described above.

In these devices, the masking determination unit 4a determines a masking state of content sounds and ambient sounds on the basis of the content sound data CT of multiple channels output from the multiple drivers 2 disposed on the headphone 1, the ambient sound data S1 obtained by the multiple microphones 3 disposed on the headphone 1 and collecting ambient sounds, and information associated with arrival directions of the ambient sounds.

The sound processing control unit 4b controls sound processing according to a determination result of the masking state obtained by the masking determination unit 4a.

In this manner, control associated with sound processing can be executed in an appropriate manner for each case, such as a case where the content sound AC is masked by an ambient sound (noise AN), and a case where a necessary ambient sound is masked by a content sound. Particularly, masking situations of a generally-called multimicrophone and multidriver headphone can be more appropriately determined by determining a masking state in additional consideration of a level and an arrival direction of an ambient sound, a channel of a content sound (information indicating an output position for outputting the content sound), and levels of respective channels. Accordingly, appropriate sound processing control is achievable according to a highly accurate masking situation determination during reproduction of stereoscopic sound content such as 3D audio. For example, recognition of an ambient sound necessary for the user, more comfortable hearing of content sounds by appropriate NC processing, reduction of system processing loads, and the like are achievable.

According to the example of the second embodiment described above, the sound processing control unit 4b performs control for outputting from the driver 2 a sound enabling recognition of an ambient sound according to the sound type of the ambient sound data S1 and a determination result of a masking state (see FIG. 36).

For example, all ambient sounds are not necessarily noises for the user enjoying stereoscopic sound. For example, these sounds may contain a sound necessary for safety or for the daily life of the user. Accordingly, in a case where an ambient sound of a certain type is determined to be necessary according to the type of the ambient sound, this ambient sound is output from the driver 2 to allow the user to recognize the sound. In this manner, the user can enjoy stereoscopic sound while appropriately hearing the ambient sound.

Described in the second embodiment has been the example where the driver 2 outputting a sound enabling recognition of an ambient sound is determined according to the arriving direction of the ambient sound.

By determining the driver 2 (i.e., determining the channel) in the manner described above, the user recognizes an arrival of a sound in a direction corresponding to the determined channel. Accordingly, the user is allowed to hear the ambient sound itself, and a notification sound or a message voice substituted for the ambient sound, and also recognize the arrival direction of the actual ambient sound.

Concerning the arrival direction of the ambient sound, user's own actions and movements can be followed in real time by constant analyzation of the ambient sound data S1 collected by the microphones 3 of the headphone 1.

According to the example of the second embodiment described above, control is performed such that a sound produced by signal-processing the ambient sound data S1 obtained by the microphone 3 is output from the driver 2 as the sound enabling recognition of an ambient sound (step S211 in FIG. 36).

In this manner, such a situation is not caused where a necessary ambient sound cannot be heard due to masking. Accordingly, the user can recognize an actual ambient sound even while hearing stereoscopic sound via the headphone 1.

Also described in the second embodiment has been the example of control for causing the driver 2 to output a generated sound enabling recognition of an ambient sound (step S212 in FIG. 36).

For example, a sound indicating any caution, warning, and notice, such as a beep sound and a message voice, is generated and output. In this manner, even when a necessary ambient sound is not heard due to masking or noise cancelling by a content sound, the user is enabled to recognize a surrounding situation (a situation where the necessary ambient sound is currently generated).

According to the second embodiment described above, the determination unit 4 (the sound processing control unit 4b) performs a process for transmitting to the host device 100 the notification information SS used for display enabling recognition of an ambient sound according to a sound type of the ambient sound data S1 and a determination result of a masking state (step S220 in FIG. 36).

For example, in a case of detection of an ambient sound determined to be necessary for the user, information used for display enabling recognition of an ambient sound is transmitted to the host device 100. According to this information, the host device 100 is caused to execute display enabling recognition of the ambient sound as explained with reference to FIGS. 30 to 35. In a case where the user is viewing and hearing stereoscopic sound content containing images, the user is also gazing at the screen. Accordingly, a notification of a necessary ambient sound by display is also effective.

Described in the second embodiment has been the example where the notification information SS used for display enabling recognition of an ambient sound contains information indicating the arrival direction of the ambient sound.

In this manner, an external device such as the host device 100 can present display corresponding to the arrival direction of the ambient sound (see FIGS. 30 to 35).

Described in the second embodiment has been the example where the notification information SS used for display enabling recognition of an ambient sound contains information indicating the type of the ambient sound.

In this manner, an external device such as the host device 100 can present display corresponding to the type of the ambient sound, such as sounds of cars and footsteps (see FIGS. 31 to 35).

Described in the second embodiment has been the example where the notification information SS used for display enabling recognition of an ambient sound contains information indicating a determination result of a masking state.

In this manner, an external device such as the host device 100 can present display indicating such a situation where the ambient sound is masked by the content sound, for example (see FIGS. 33 to 35).

According to the examples of the first and second embodiments described above, the sound processing control unit 4b controls noise cancelling for an ambient sound according to a determination result of a masking state.

NC processing performed for the ambient sound can reduce or eliminate the ambient sound present around the user enjoying stereoscopic sound content. However, NC processing need not be performed for an ambient sound originally masked. Accordingly, efficiency of NC processing can be raised by controlling NC processing according to the masking determination result. Specifically, NC processing may be executed for an ambient sound not masked by the content sound depending on a frequency component or an arrival direction, and may be prohibited for a masked ambient sound.

Moreover, the sound processing control unit 4b may also control NC processing on the basis of the sound type of ambient sound data obtained by the microphones 3.

For example, in a case where the ambient sound is determined to be necessary for the user, NC processing may be prohibited to allow the user to hear this ambient sound.

According to the examples of the first and second embodiments described above, the sound processing control unit 4b performs control for determining the driver 2 (i.e., channel) outputting an NC sound for an ambient sound according to a determination result of a masking state and information indicating the arrival direction of the ambient sound.

For performing NC processing for the ambient sound, the NC effect becomes more effective by determining the driver 2 which outputs the NC sound ANC according to the arrival direction of the ambient sound.

According to the example of the first embodiment described above, the sound processing control unit 4b performs a process for transmitting to the host device 100 quantization bit information necessary for the content sound data CT according to a determination result of a masking state.

Concerning stereoscopic sound reproduction, the transmission bit rate is considerably increasing with realization of multiple viewpoints and free viewpoints. Accordingly, reduction of the transmission bit rate of content sound data is one of important issues to be solved. In the embodiment herein, the necessity of transmitting information associated with sound components to be masked is eliminated, and therefore the number of quantization bits can be reduced. Accordingly, quantization bit information necessary for the content sound data is transmitted to the host device 100 according to a determination result of a masking state. In this manner, reduction of a data volume of the content sound data is achievable by the host device 100. As a result, reduction of the transmission bit rate of the content sound data, improvement of the S/N of content signals, improvement of a sense of sound separation, improvement of the NC effect, or elongation of the battery life of the headphone 1 due to reduction of power consumption is achievable.

The quantization bit information transmitted to the host device 100 in the first embodiment contains information associated with a channel and a band included in the content sound data and corresponding to reduction targets of the number of quantization bits.

In this case, the host device 100 can reduce the number of quantization bits in a designated band in a designated channel.

Note that the determination unit 4 (sound processing control unit 4b) can selectively perform power source off control for the drivers 2. For example, this control is for cutting off power source supply to the driver 2 of the channel not outputting an NC sound nor a content sound.

Constant monitoring of the driver 2 not temporarily used, and cut-off of power source supply to the corresponding driver 2 in this manner can reduce power consumption, and contribute to elongation of the battery life of the headphone 1.

Moreover, while the sound output device described in the embodiments by way of example is the headphone 1, the technology according to the present disclosure is also applicable to sound output devices constituting various types of earphones, such as an inner-ear type and a canal type.

Note that advantageous effects described in the present description are presented only as examples and not by way of limitation. In addition, other advantageous effects may be produced.

Note that the present technology may be implemented preferably in the following configurations.
(1)

A signal processing device including:
a masking determination unit that determines a masking state of a content sound and an ambient sound on a basis of content sound data of multiple channels output from multiple sound output drivers disposed on a sound output device, ambient sound data obtained by multiple microphones disposed on the sound output device and each collecting the ambient sound, and information indicating an arrival direction of the ambient sound; and
a sound processing control unit that performs control associated with sound processing according to a determination result of the masking state obtained by the masking determination unit.
(2)

The signal processing device according to (1) above, in which the sound processing control unit performs control for outputting from one of the sound output drivers a sound enabling recognition of the ambient sound, according to a sound type of the ambient sound data obtained by the microphones and the determination result of the masking state.
(3)

The signal processing device according to (2) above, in which the sound processing control unit determines the sound output driver that is included in the multiple sound output drivers and that outputs the sound enabling recognition of the ambient sound, according to the arrival direction of the ambient sound.
(4)

The signal processing device according to (2) or (3) above, in which the sound processing control unit performs control for outputting from one of the sound output drivers a sound produced by signal-processing the ambient sound obtained by the microphones, as the sound enabling recognition of the ambient sound.
(5)

The signal processing device according to (2) or (3) above, in which the sound processing control unit performs control for outputting from one of the sound output drivers a generated sound enabling recognition of the ambient sound.
(6)

The signal processing device according to any one of (1) to (5) above, in which the sound processing control unit performs a process for transmitting to an external device information used for display enabling recognition of the ambient sound, according to a sound type of the ambient sound data obtained by the microphones and the determination result of the masking state.
(7)

The signal processing device according to (6) above, in which the sound processing control unit performs a process for transmitting to the external device information that is used for display enabling recognition of the ambient sound and contains information indicating the arrival direction of the ambient sound.
(8)

The signal processing device according to (6) or (7) above, in which the sound processing control unit performs a process for transmitting to the external device information that is used for display enabling recognition of the ambient sound and contains information indicating a type of the ambient sound.
(9)

The signal processing device according to any one of (6) to (8) above, in which the sound processing control unit performs a process for transmitting to the external device information that is used for display enabling recognition of the ambient sound and contains information indicating the determination result of the masking state.
(10)

The signal processing device according to any one of (1) to (9) above, in which the sound processing control unit controls noise cancelling for the ambient sound according to the determination result of the masking state.
(11)

The signal processing device according to any one of (1) to (10) above, in which the sound processing control unit performs control for determining the sound output driver that is included in the multiple sound output drivers and that outputs a noise cancelling signal for the ambient sound, according to the determination result of the masking state and the information indicating the arrival direction of the ambient sound.
(12)

The signal processing device according to any one of (1) to (11) above, in which the sound processing control unit performs a process for transmitting to an external device quantization bit information necessary for the content sound data according to the determination result of the masking state.
(13)

The signal processing device according to (12) above, in which the quantization bit information transmitted to the external device contains information associated with a channel and a band included in the content sound data and corresponding to reduction targets of the number of quantization bits.
(14)

A sound output device including:
multiple sound output drivers;
multiple microphones each collecting an ambient sound;
a masking determination unit that determines a masking state of a content sound and an ambient sound on a basis of content sound data of multiple channels output from the sound output drivers, ambient sound data obtained by the microphones, and information indicating an arrival direction of the ambient sound; and
a sound processing control unit that performs control associated with sound processing according to a determination result of the masking state obtained by the masking determination unit.
(15)

A signal processing method executed by a signal processing device, the method including:
a masking determination process that determines a masking state of a content sound and an ambient sound on a basis of content sound data of multiple channels output from multiple sound output drivers disposed on a sound output device, ambient sound data obtained by multiple microphones disposed on the sound output device and each collecting the ambient sound, and information indicating an arrival direction of the ambient sound; and
a sound processing control process that performs control associated with sound processing according to a determination result of the masking state obtained by the masking determination process.

### REFERENCE SIGNS LIST

1: Headphone
2, 2A, and up to 2(N): Sound output driver (driver)
3, 3A, and up to 3(M): Microphone
4: Determination unit
4a: Masking determination unit
4b: Sound processing control unit
5: Ambient sound type determination unit
6: NC signal generation unit
7: Output signal generation unit
8: Ambient sound signal processing unit
100: Host device
200: Ear
201: Eardrum
AC: Content sound
AN: Noise
AN (NC): Uncancelled noise
ANC: NC sound
S1: Ambient sound data
S2: NC sound data
S3: Sound data
SS: Notification information
CT: Content sound data

1. A signal processing device comprising:
a masking determination unit that determines a masking state of a content sound and an ambient sound on a basis of content sound data of multiple channels output from multiple sound output drivers disposed on a sound output device, ambient sound data obtained by multiple microphones disposed on the sound output device and each collecting the ambient sound, and information indicating an arrival direction of the ambient sound; and
a sound processing control unit that performs control associated with sound processing according to a determination result of the masking state obtained by the masking determination unit.

2. The signal processing device according to claim 1, wherein the sound processing control unit performs control for outputting from one of the sound output drivers a sound enabling recognition of the ambient sound, according to a sound type of the ambient sound data obtained by the microphones and the determination result of the masking state.

3. The signal processing device according to claim 2, wherein the sound processing control unit determines the sound output driver that is included in the multiple sound output drivers and that outputs the sound enabling recognition of the ambient sound, according to the arrival direction of the ambient sound.

4. The signal processing device according to claim 2, wherein the sound processing control unit performs control for outputting from one of the sound output drivers a sound produced by signal-processing the ambient sound obtained by the microphones, as the sound enabling recognition of the ambient sound.

5. The signal processing device according to claim 2, wherein the sound processing control unit performs control for outputting from one of the sound output drivers a generated sound enabling recognition of the ambient sound.

6. The signal processing device according to claim 1, wherein the sound processing control unit performs a process for transmitting to an external device information used for display enabling recognition of the ambient sound, according to a sound type of the ambient sound data obtained by the microphones and the determination result of the masking state.

7. The signal processing device according to claim 6, wherein the sound processing control unit performs a process for transmitting to the external device information that is used for display enabling recognition of the ambient sound and contains information indicating the arrival direction of the ambient sound.

8. The signal processing device according to claim 6, wherein the sound processing control unit performs a process for transmitting to the external device information that is used for display enabling recognition of the ambient sound and contains information indicating a type of the ambient sound.

9. The signal processing device according to claim 6, wherein the sound processing control unit performs a process for transmitting to the external device information that is used for display enabling recognition of the ambient sound and contains information indicating the determination result of the masking state.

10. The signal processing device according to claim 1, wherein the sound processing control unit controls noise cancelling for the ambient sound according to the determination result of the masking state.

11. The signal processing device according to claim 1, wherein the sound processing control unit performs control for determining the sound output driver that is included in the multiple sound output drivers and that outputs a noise cancelling signal for the ambient sound, according to the determination result of the masking state and the information indicating the arrival direction of the ambient sound.

12. The signal processing device according to claim 1, wherein the sound processing control unit performs a process for transmitting to an external device quantization bit information necessary for the content sound data according to the determination result of the masking state.

13. The signal processing device according to claim 12, wherein the quantization bit information transmitted to the external device contains information associated with a channel and a band included in the content sound data and corresponding to reduction targets of the number of quantization bits.

14. A sound output device comprising:
multiple sound output drivers;
multiple microphones each collecting an ambient sound;
a masking determination unit that determines a masking state of a content sound and an ambient sound on a basis of content sound data of multiple channels output from the sound output drivers, ambient sound data obtained by the microphones, and information indicating an arrival direction of the ambient sound; and
a sound processing control unit that performs control associated with sound processing according to a determination result of the masking state obtained by the masking determination unit.

15. A signal processing method executed by a signal processing device, the method comprising:
a masking determination process that determines a masking state of a content sound and an ambient sound on a basis of content sound data of multiple channels output from multiple sound output drivers disposed on a sound output device, ambient sound data obtained by multiple microphones disposed on the sound output device and each collecting the ambient sound, and information indicating an arrival direction of the ambient sound; and
a sound processing control process that performs control associated with sound processing according to a determination result of the masking state obtained by the masking determination process.
